(19) United States
(12) Patent Application Publication
(10) Pub. No.: US 2025/0267533 A1
(43) Pub. Date: Aug. 21, 2025

(54) RANDOM ACCESS TECHNIQUES FOR HANDOVER FROM AN ACCESS NETWORK

(71) Applicant: QUALCOMM Incorporated, San Diego, CA (US)

(72) Inventors: Sankara Subramaniam B S, Bengaluru (IN); Subramanian ANANTHARAMAN, Bangalore (IN)

(21) Appl. No.: 18/582,444

(22) Filed: Feb. 20, 2024

(51) Int. Cl. H04W 36/00; H04W 36/14

(52) U.S. Cl. CPC H04W 36/0072; H04W 36/144

(57) ABSTRACT

Methods, systems, and devices for wireless communications are described. In some examples, a user equipment (UE) may perform a two-step random access procedure including a unique preamble as part of a handover procedure from a first RAT to a second RAT. The UE may receive random access information including the unique preamble and a configuration for a connection request message from an access network associated with the first RAT. In some examples, the unique preamble may be based on locational information associated with the UE. The UE may transmit a random access message including the unique preamble and the connection request message to a network entity associated with the second RAT. The UE may communicate with the network via the second RAT based on communicating the random access message including the unique preamble and the connection request.

### FIELD OF TECHNOLOGY

The following relates to wireless communications, including random access techniques for handover from an access network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support a private network, which may be a non-public mobile network that may use licensed, unlicensed, or shared radio frequency (RF) spectrum bands. The private network may be intended for private (e.g., non-public use) by a customer or organization.

### SUMMARY

The described techniques relate to improved methods, systems, devices, and apparatuses that support random access techniques for handover from an access network. For example, the described techniques enable a user equipment (UE) to perform a two-step random access procedure using a unique preamble as part of a handover procedure from a first radio access technology (RAT) to a second RAT. The UE may receive random access information including the unique preamble and a configuration for a connection request message from an access network associated with the first RAT. In some examples, the unique preamble may be based on locational information associated with the UE. In such examples, a wireless service function may determine the locational information and indicate the locational information to a network entity associated with the second RAT. The network entity may determine the random access information and transmit the random access information to the access network. The access network may relay the random access information to the UE. The UE may transmit a random access message including the unique preamble and the connection request message to a network entity associated with the second RAT. The UE may communicate with the network via the second RAT based on communicating the random access message including the unique preamble and the connection request.

A method for wireless communications by a UE is described. The method may include establishing, via a network function of an access network associated with a first RAT type, a connection with a network of a second RAT type, receiving, via the network function, a message including a payload indicating random access information for the second RAT type for the UE, the random access information including a preamble for the UE and a temporary identifier (ID) for the UE, where the preamble and the temporary ID are based on location information associated with the UE, and transmitting a random access message to a network entity associated with the second RAT type based on the message indicating the random access information, the random access message including the preamble for the UE and a request to connect with the network of the second RAT type.

A UE for wireless communications is described. The UE may include one or more memories storing processor executable code, and one or more processors coupled with the one or more memories. The one or more processors may individually or collectively be operable to execute the code to cause the UE to establish, via a network function of an access network associated with a first RAT type, a connection with a network of a second RAT type, receive, via the network function, a message including a payload indicating random access information for the second RAT type for the UE, the random access information including a preamble for the UE and a temporary ID for the UE, where the preamble and the temporary ID are based on location information associated with the UE, and transmit a random access message to a network entity associated with the second RAT type based on the message indicating the random access information, the random access message including the preamble for the UE and a request to connect with the network of the second RAT type.

Another UE for wireless communications is described. The UE may include means for establishing, via a network function of an access network associated with a first RAT type, a connection with a network of a second RAT type, means for receiving, via the network function, a message including a payload indicating random access information for the second RAT type for the UE, the random access information including a preamble for the UE and a temporary ID for the UE, where the preamble and the temporary ID are based on location information associated with the UE, and means for transmitting a random access message to a network entity associated with the second RAT type based on the message indicating the random access information, the random access message including the preamble for the UE and a request to connect with the network of the second RAT type.

A non-transitory computer-readable medium storing code for wireless communications is described. The code may include instructions executable by one or more processors to establish, via a network function of an access network associated with a first RAT type, a connection with a network of a second RAT type, receive, via the network function, a message including a payload indicating random access information for the second RAT type for the UE, the random access information including a preamble for the UE and a temporary ID for the UE, where the preamble and the temporary ID are based on location information associated with the UE, and transmit a random access message to a network entity associated with the second RAT type based on the message indicating the random access information, the random access message including the preamble for the UE and a request to connect with the network of the second RAT type.

Some examples of the method, user equipment (UEs), and non-transitory computer-readable medium described herein may further include operations, features, means, or instructions for deactivating, after establishment of the connection with the network of the second RAT type via the network function, a radio frequency (RF) chain associated with the second RAT type and activating the RF chain associated with the second RAT type based on reception of the payload of the message indicating the random access information for the second RAT type for the UE.

Some examples of the method, user equipment (UEs), and non-transitory computer-readable medium described herein may further include operations, features, means, or instructions for transmitting, to the network function, an informational exchange message indicating that the UE received the message indicating the random access information, the informational exchange message including no payload or including one or more vendor-specific payloads.

In some examples of the method, user equipment (UEs), and non-transitory computer-readable medium described herein, transmitting the random access message may include operations, features, means, or instructions for transmitting a physical random access channel (PRACH) including the preamble and the temporary ID.

In some examples of the method, user equipment (UEs), and non-transitory computer-readable medium described herein, the random access message may be an initial message of a two-step random access procedure, the initial message including both the PRACH and a physical uplink shared channel (PUSCH) including the request to connect with the network of the second RAT type.

In some examples of the method, user equipment (UEs), and non-transitory computer-readable medium described herein, the access network may be a non-3GPP inter-working function (N3IWF) or a trusted non-3GPP gateway function (TNGF).

Some examples of the method, user equipment (UEs), and non-transitory computer-readable medium described herein may further include operations, features, means, or instructions for communicating, after transmission of the random access message, with the network entity via a RF chain associated with the second RAT type, where the random access information may be based on precise location information for the UE.

Some examples of the method, user equipment (UEs), and non-transitory computer-readable medium described herein may further include operations, features, means, or instructions for deactivating, after transmitting the random access message to the network entity, a RF chain associated with the first RAT type.

In some examples of the method, user equipment (UEs), and non-transitory computer-readable medium described herein, the preamble may be unique to the UE.

In some examples of the method, user equipment (UEs), and non-transitory computer-readable medium described herein, the first RAT type may be a wireless local area network (WLAN) RAT and the second RAT type may be a cellular network RAT.

A method for wireless communications by a service function is described. The method may include transmitting location information associated with a UE that is connected, via a network function of an access network associated with a first RAT type, to a network associated with a second RAT type, the location information including a global ID and a current location of the UE, receiving random access information for the second RAT type for the UE, the random access information including a preamble for the UE and a temporary ID for the UE, where the preamble and the temporary ID are based on the location information associated with the UE, and transmitting, to the network function of the access network associated with the first RAT type, an indication of the random access information for the second RAT type for the UE.

A service function for wireless communications is described. The service function may include one or more memories storing processor executable code, and one or more processors coupled with the one or more memories. The one or more processors may individually or collectively be operable to execute the code to cause the service function to transmit location information associated with a UE that is connected, via a network function of an access network associated with a first RAT type, to a network associated with a second RAT type, the location information including a global ID and a current location of the UE, receive random access information for the second RAT type for the UE, the random access information including a preamble for the UE and a temporary ID for the UE, where the preamble and the temporary ID are based on the location information associated with the UE, and transmit, to the network function of the access network associated with the first RAT type, an indication of the random access information for the second RAT type for the UE.

Another service function for wireless communications is described. The service function may include means for transmitting location information associated with a UE that is connected, via a network function of an access network associated with a first RAT type, to a network associated with a second RAT type, the location information including a global ID and a current location of the UE, means for receiving random access information for the second RAT type for the UE, the random access information including a preamble for the UE and a temporary ID for the UE, where the preamble and the temporary ID are based on the location information associated with the UE, and means for transmitting, to the network function of the access network associated with the first RAT type, an indication of the random access information for the second RAT type for the UE.

A non-transitory computer-readable medium storing code for wireless communications is described. The code may include instructions executable by one or more processors to transmit location information associated with a UE that is connected, via a network function of an access network associated with a first RAT type, to a network associated with a second RAT type, the location information including a global ID and a current location of the UE, receive random access information for the second RAT type for the UE, the random access information including a preamble for the UE and a temporary ID for the UE, where the preamble and the temporary ID are based on the location information associated with the UE, and transmit, to the network function of the access network associated with the first RAT type, an indication of the random access information for the second RAT type for the UE.

In some examples of the method, service functions, and non-transitory computer-readable medium described herein, transmitting the location information may include operations, features, means, or instructions for transmitting an E2 application protocol (E2AP) radio access network (RAN) intelligent controller (RIC) control request message that includes the location information.

In some examples of the method, service functions, and non-transitory computer-readable medium described herein, transmitting the location information may include operations, features, means, or instructions for transmitting the location information via an E2-t interface.

In some examples of the method, service functions, and non-transitory computer-readable medium described herein, the service function may be a near-real time RIC (near-RT RIC).

In some examples of the method, service functions, and non-transitory computer-readable medium described herein, the global ID may be a globally unique temporary ID (GUTI) or a subscription permanent ID (SUPI).

In some examples of the method, service functions, and non-transitory computer-readable medium described herein, the preamble may be unique to the UE.

In some examples of the method, service functions, and non-transitory computer-readable medium described herein, the first RAT type may be a WLAN RAT and the second RAT type may be a cellular network RAT.

A method for wireless communications by a network entity associated with a RAT type is described. The method may include obtaining, from a service function, location information associated with a UE, the location information including a global ID and a current location of the UE, outputting random access information for the RAT type to the service function, the random access information including a preamble for the UE and a temporary ID for the UE, where the preamble and the temporary ID are based on the location information associated with the UE, and obtaining a random access message from the UE based on the random access information, the random access message including the preamble for the UE and a request for the UE to connect with the network entity associated with the RAT type.

A network entity associated with a RAT type for wireless communications is described. The network entity associated with a RAT type may include one or more memories storing processor executable code, and one or more processors coupled with the one or more memories. The one or more processors may individually or collectively be operable to execute the code to cause the network entity associated with a RAT type to obtain, from a service function, location information associated with a UE, the location information including a global ID and a current location of the UE, output random access information for the RAT type to the service function, the random access information including a preamble for the UE and a temporary ID for the UE, where the preamble and the temporary ID are based on the location information associated with the UE, and obtain a random access message from the UE based on the random access information, the random access message including the preamble for the UE and a request for the UE to connect with the network entity associated with the RAT type.

Another network entity associated with a RAT type for wireless communications is described. The network entity associated with a RAT type may include means for obtaining, from a service function, location information associated with a UE, the location information including a global ID and a current location of the UE, means for outputting random access information for the RAT type to the service function, the random access information including a preamble for the UE and a temporary ID for the UE, where the preamble and the temporary ID are based on the location information associated with the UE, and means for obtaining a random access message from the UE based on the random access information, the random access message including the preamble for the UE and a request for the UE to connect with the network entity associated with the RAT type.

A non-transitory computer-readable medium storing code for wireless communications is described. The code may include instructions executable by one or more processors to obtain, from a service function, location information associated with a UE, the location information including a global ID and a current location of the UE, output random access information for the RAT type to the service function, the random access information including a preamble for the UE and a temporary ID for the UE, where the preamble and the temporary ID are based on the location information associated with the UE, and obtain a random access message from the UE based on the random access information, the random access message including the preamble for the UE and a request for the UE to connect with the network entity associated with the RAT type.

Some examples of the method, network entities associated with a RAT, and non-transitory computer-readable medium described herein may further include operations, features, means, or instructions for determining the random access information including the preamble and the temporary ID based on the location information associated with the UE.

In some examples of the method, network entities associated with a RAT, and non-transitory computer-readable medium described herein, outputting the random access information may include operations, features, means, or instructions for outputting the random access information to the service function via an E2AP RAN RIC control acknowledgment message.

Some examples of the method, network entities associated with a RAT, and non-transitory computer-readable medium described herein may further include operations, features, means, or instructions for outputting or obtaining one or more messages with the UE based on reception of the random access message.

Some examples of the method, network entities associated with a RAT, and non-transitory computer-readable medium described herein may further include operations, features, means, or instructions for outputting or obtaining one or more messages with the UE, where the location information includes precise location information for the UE.

In some examples of the method, network entities associated with a RAT, and non-transitory computer-readable medium described herein, the preamble may be unique to the UE.

In some examples of the method, network entities associated with a RAT, and non-transitory computer-readable medium described herein, the RAT type may be a cellular network RAT.

### BRIEF DESCRIPTION OF THE DRAWINGS

FIG. 1 shows an example of a wireless communications system that supports random access techniques for handover from an access network in accordance with one or more aspects of the present disclosure.

FIG. 2 shows an example of a network architecture that supports random access techniques for handover from an access network in accordance with one or more aspects of the present disclosure.

FIG. 3 shows an example of a wireless communications system that supports random access techniques for handover from an access network in accordance with one or more aspects of the present disclosure.

FIG. 4 shows an example of a flowchart that supports random access techniques for handover from an access network in accordance with one or more aspects of the present disclosure.

FIG. 5 shows an example of a process flow that supports random access techniques for handover from an access network in accordance with one or more aspects of the present disclosure.

FIGS. 6 and 7 show block diagrams of devices that support random access techniques for handover from an access network in accordance with one or more aspects of the present disclosure.

FIG. 8 shows a block diagram of a communications manager that supports random access techniques for handover from an access network in accordance with one or more aspects of the present disclosure.

FIG. 9 shows a diagram of a system including a device that supports random access techniques for handover from an access network in accordance with one or more aspects of the present disclosure.

FIGS. 10 and 11 show block diagrams of devices that support random access techniques for handover from an access network in accordance with one or more aspects of the present disclosure.

FIG. 12 shows a block diagram of a communications manager that supports random access techniques for handover from an access network in accordance with one or more aspects of the present disclosure.

FIG. 13 shows a diagram of a system including a device that supports random access techniques for handover from an access network in accordance with one or more aspects of the present disclosure.

FIGS. 14 and 15 show block diagrams of devices that support random access techniques for handover from an access network in accordance with one or more aspects of the present disclosure.

FIG. 16 shows a block diagram of a communications manager that supports random access techniques for handover from an access network in accordance with one or more aspects of the present disclosure.

FIG. 17 shows a diagram of a system including a device that supports random access techniques for handover from an access network in accordance with one or more aspects of the present disclosure.

FIGS. 18 through 22 show flowcharts illustrating methods that support random access techniques for handover from an access network in accordance with one or more aspects of the present disclosure.

### DETAILED DESCRIPTION

In some wireless communications systems, a user equipment (UE) may be in communications with a core network (e.g., a Fifth Generation (5G) core network). In some examples, the UE may communicate with the core network via a first RAT (e.g., a Wi-Fi RAT) and a second RAT (e.g., a 5G RAT). For example, the UE may be within a region (e.g., a geographical coverage area) associated with the first RAT (e.g., may be serviced by the first RAT). In some examples, the UE may move into a region serviced by the second RAT and experience handover procedure to switch communicating with the core network via the first RAT to the second RAT. As a part of the handover procedure, the UE may register with (e.g., establish communications with) the network entity.

In some examples, the UE may perform a four-step random access channel (RACH) procedure with the network entity. The four-step RACH procedure may include transmitting a random preamble to the network entity, receiving a random access response (RAR) from the network entity, and communicating additional messages for collision resolution due to the simultaneous transmission of a same preamble from multiple UEs. However, performing a four-step RACH procedure to establish communications between the UE and the network entity may require multiple round-trip communication cycles between the UE and the network entity, which may introduce latency, signaling overhead, or a delay in the handover operation. In some other examples, the UE may perform a two-step RACH procedure to establish communications to reduce the quantity of round-trip cycles between the UE and the network entity. However, the UE and network entity may still communicate some messages for collision resolution, which may introduce additional round-trip cycles between the UE and the network entity.

Various aspects of the present disclosure are related to random access techniques for handover from access networks. In some examples, a UE may perform a two-step RACH procedure with a network entity as part of a handover procedure from a first RAT to a second RAT. The UE may receive an indication of random access information associated with the second RAT including a unique preamble and a configuration for a connection request message from an access network associated with the first RAT and may transmit a first random access (e.g., msgA) including the unique preamble and the connection request message to the network entity. The UE may communicate with the network via the second RAT based on communicating the msgA including the preamble and the connection request. In some examples, the unique preamble may be based on locational information associated with the UE, and the network entity may determine the random access information including the preamble based on an indication of the locational information received from a wireless communications service. The wireless communications service may receive an indication of the random access information from the network entity and may transmit the random access information to the access network associated with the first RAT.

Aspects of the disclosure are initially described in the context of wireless communications systems. Aspects of the disclosure are additionally described by flowcharts and process flows. Aspects of the disclosure are further illustrated by and described with reference to apparatus diagrams, system diagrams, and flowcharts that relate to random access techniques for handover from an access network.

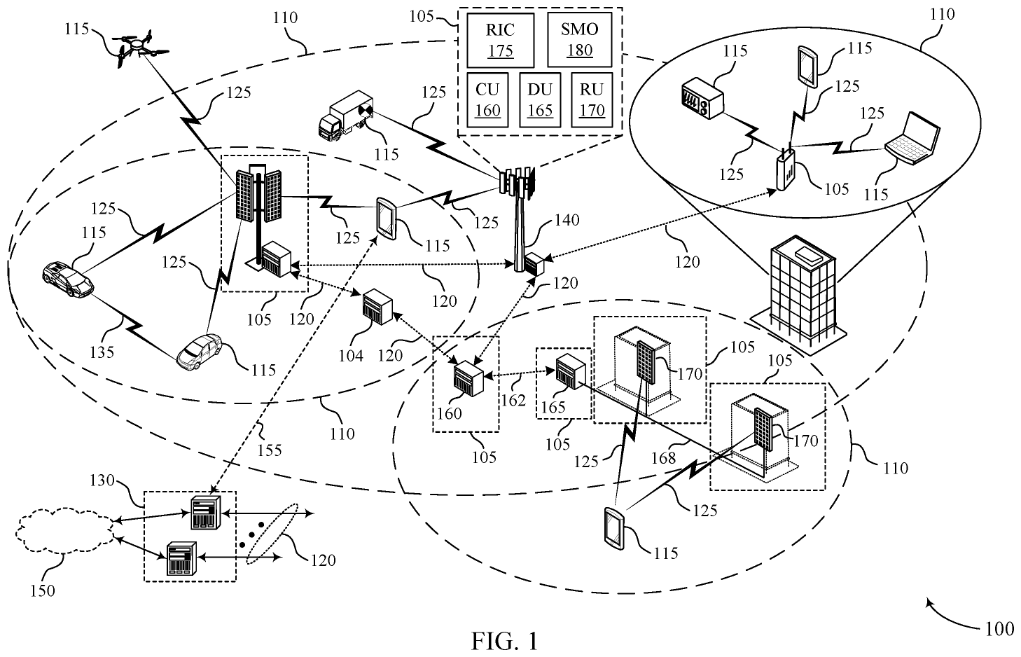

FIG. 1 shows an example of a wireless communications system 100 that supports random access techniques for handover from an access network in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 of the wireless communications system 100 may communicate with a core network 130 (e.g., a 5G core network). In some examples, the UE 115 may be serviced by a cell that is associated with a first RAT (e.g., Wi-Fi) different from a second RAT associated with the core network (e.g., 5G). In some cases, the UE 115 may move between cells (e.g., coverage areas 110), triggering a handover operation. As a part of the handover procedure, the UE 115 may register with (e.g., establish communications with) a network entity 105 associated with the second RAT.

In some examples, the UE 115 may perform a four-step random access channel (RACH) procedure with the network entity 105. However, performing a four-step RACH procedure to establish communications between the UE 115 and the network entity 105 may include multiple round-trip communication cycles between the UE 115 and the network entity 105, which may introduce latency, signaling overhead, and a delay in the handover operation. In some other examples, the UE 115 may perform a two-step RACH procedure to establish communications to reduce the quantity of round-trip cycles between the UE 115 and the network entity 105. However, the UE 115 and network entity 105 may still communicate additional messages for collision resolution, which may introduce additional round-trip cycles between the UE 115 and the network entity 105.

Techniques, systems, and devices described herein provide for random access techniques for handover from access networks. In some examples, a UE 115 may perform a two-step RACH procedure using a unique preamble with a network entity 105 as part of a handover procedure from a first RAT to a second RAT. The UE 115 may receive random access information including the unique preamble and a configuration for a connection request message from an access network associated with the first RAT (e.g., a non-3GPP network). In some examples, the network entity 105 may determine the unique preamble based on locational information associated with the UE 115. A wireless communications service may receive an indication of the random access information from the network entity 105 and may transmit the random access information to the access network associated with the first RAT. The UE 115 may transmit a random access message including the unique preamble and the connection request message to the network entity 105. The UE 115 may communicate with the network via the second RAT based on communicating the random access message including the unique preamble and the connection request.

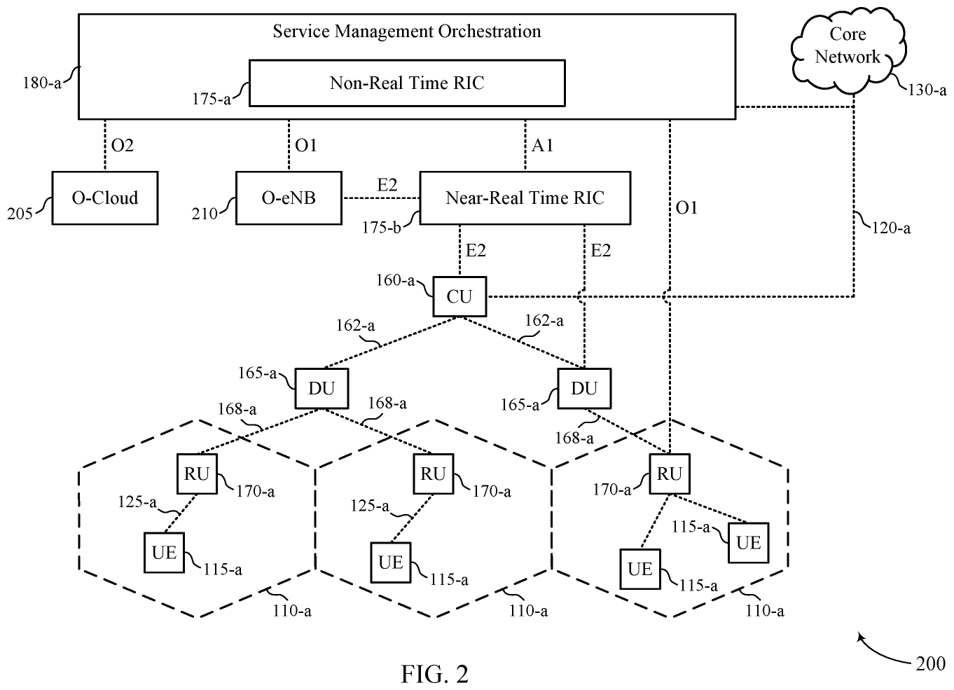

FIG. 2 shows an example of a network architecture 200 (e.g., a disaggregated base station architecture, a disaggregated RAN architecture) that supports random access techniques for handover from an access network in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples, the network architecture 200 may represent an example of a private network, which may be a non-public mobile network that may use a licensed, unlicensed, or shared RF spectrum and may be intended for non-public (e.g., private) use by, for example, an organization or company (e.g., for precision agriculture, construction and mining, digitized education, connected healthcare, connected cities, intelligent retail, smart manufacturing, and mobile experiences, among other examples). In some examples, the private network may leverage or be based on a second type of network protocols, such as 3GPP protocols, and may be referred to as a second type of network accordingly (e.g., a 3GPP network or a 5G network).

In some examples, a UE 115-a may communicate with a core network 130-a. In some examples, the UE 115-a may be serviced by a cell that is associated with a first RAT (e.g., Wi-Fi) different from a second RAT associated with the core network (e.g., 5G). In some cases, the UE 115-a may move between cells (e.g., coverage areas 110), triggering a handover operation. As a part of the handover procedure, the UE 115-a may register with (e.g., establish communications with) a network entity associated with the second RAT. For example, the UE 115-a may perform a RACH procedure with the network entity. However, performing a four-step RACH procedure to establish communications between the UE 115-a and the network entity may include multiple round-trip communication cycles between the UE 115-a and the network entity, which may introduce latency, signaling overhead, and a delay in the handover operation. In some other examples, the UE 115-a may perform a two-step RACH procedure to establish communications to reduce the quantity of round-trip cycles between the UE 115-a and the network entity. However, the UE 115-a and network entity may still communicate additional messages for collision resolution, which may introduce additional round-trip cycles between the UE 115-a and the network entity.

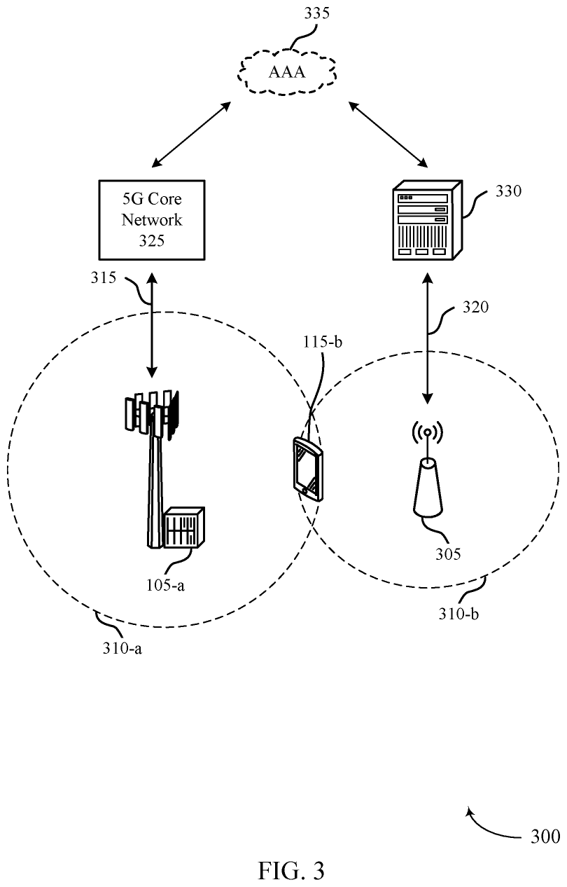

Techniques, systems, and devices described herein provide for reduced latency of handover between a non-3GPP network and a 3GPP network by utilizing a two-step CFRA RACH procedure. Such procedures may be utilized to reduce signaling overhead and latency during device registration to facilitate a reduced potential for message collision during device registration and a faster registration procedure between the UE 115 and the 3GPP network, as described in further detail elsewhere herein, including with reference to FIGS. 3-5.

In some examples, a UE 115-a may perform a two-step RACH procedure including a unique preamble with a network entity as part of a handover procedure from a first RAT to a second RAT. The UE 115-a may receive random access information including the unique preamble and a configuration for a connection request message from an access network associated with the first RAT (e.g., a non-3GPP network). In some examples, the network entity may determine the unique preamble based on locational information associated with the UE 115-a. A wireless communications service may receive an indication of the random access information from the network entity and may transmit the random access information to the access network associated with the first RAT. The UE 115-a may transmit a random access message including the unique preamble and the connection request message to the network entity. The UE 115-a may communicate with the network via the second RAT based on communicating the random access message including the unique preamble and the connection request.

FIG. 3 shows an example of a wireless communications system 300 that supports random access techniques for handover from an access network in accordance with one or more aspects of the present disclosure. In some examples, the wireless communications system 300 may include a UE 115-b, a network entity 105-a, and a wireless access point (AP) 305. The network entity 105-a may be associated with a first coverage area 310-a and the AP 305 may be associated with a second coverage area 310-b. In some examples, the UE 115-b may support or otherwise be capable of communications via multiple RATs. For example, the UE 115-b may communicate with the network entity 105-a using a 3GPP RAT (e.g., cellular NR communications) via cellular communication link 315 (e.g., a Uu link), which may represent a home 3GPP network. Similarly, the UE 115-b may communicate with the AP 305 using a non-3GPP RAT (e.g., Wi-Fi) via wireless communication link 320, which may represent a non-3GPP network.

Both the network entity 105-a and the AP 305 may communicate with the core network 325, which may be an example of a core network 130 as described with reference to FIG. 1. In some examples, the core network 325 may be a 5G core network. Additionally, the core network 325 may be a private network (e.g., a non-public network (NPN)) or a public network. The UE 115-b may communicate with the core network 325 via the AP 305, the network entity 105-a, or both. For example, the network entity 105-a may communicate (e.g., directly) with the core network 325. Additionally, or alternatively, the AP 305 may communicate with an AP network 330 (e.g., with an AP controller of the AP network 330). The AP network (e.g., a Wi-Fi network) may be a trusted network or an untrusted network. The AP network 330 may communicate with the core network 325 via an Authentication, Authorization, and Accounting (AAA) server 335.

The UE 115-b may initially communicate with the core network 325 via the AP 305. For example, the UE 115-b may be within the second coverage area 310-b and may communicate with the AP network 330. In some examples, the UE 115-b may enter the first coverage area 310-a, which may trigger a handover procedure. The handover procedure may transfer communications between the UE 115-b and the core network 325 from the AP 305 to the network entity 105-a. In some examples, if the UE 115-b is being handed over from the non-3GPP network to the home 3GPP network (e.g., from the AP 305 to the network entity 105-a), the UE 115-b may perform registration with the network entity 105-a. In some cases, the registration procedure may be similar to a registration procedure for an RRC idle scenario. For example, the UE 115-b may perform a RACH procedure to establish communications with the network entity 105-a.

In some implementations, the UE 115-b may perform a four-step RACH procedure with the network entity 105-a. The four-step RACH procedure may, in some examples, include transmitting a randomly selected or generated preamble to the network entity 105-a, receiving a random access response (RAR) from the network entity 105-a, transmitting a RRC connection request to the network entity 105-a, and receiving a RRC connection setup message from the network entity 105-a. The UE 115-b and the network entity 105-a may communicate the RRC connection request and RRC connection setup messages for the purpose of collision resolution. For example, there may be multiple UEs 115 also transmitting a random preamble to the network entity 105-a, which may be same as the preamble transmitted by the UE 115-b. However, performing a four-step RACH procedure may introduce additional round-trip signaling between the UE 115-b and the network entity 105-a, which may increase latency. Additionally, in some cases where the network entity 105-a, the UE 115-b, or both operate in an unlicensed spectrum (e.g., frequency band), using the four-step RACH procedure may introduce additional Listen-Before-Talk operations to access the unlicensed channel. These may cause a delay in handover of the UE 115-b from the AP 305 to the network entity 105-a.

Alternatively, in some examples, the UE 115-b may perform a two-step (e.g., type-two) RACH procedure with the network entity 105-a. The two-step RACH procedure may be a contention-based random access (CBRA) procedure for reducing a quantity of signaling and latency between the UE 115-b and the network entity 105-a. All RRC states for the UE 115-b that are associated with (e.g., applicable to) the four-step RACH procedure (e.g., RRC_INACTIVE RRC_CONNECTED, RRC_IDLE) may be applicable to the two-step RACH procedure. The UE 115-b may receive an information block (e.g., SIB1) from the core network 325 indicating for (e.g., configuring) the UE 115-b to perform the four-step RACH procedure or the two-step RACH procedure. Alternatively, if the core network indicates no RACH configuration, the UE 115-b may select a RACH procedure based on a reference signal received power (RSRP) threshold of the UE 115-b.

Alternatively, in some other examples, the UE 115-b may perform a type-two contention free random access (CFRA) procedure. For example, if the UE 115-b is in an RRC_RECONFIGURATION state (e.g., during 3GPP 5G-NR inter-cell handover), the UE 115-b may perform CFRA. In such examples, the network entity 105-a may not receive multiple preambles from multiple UEs 115, and accordingly may not perform collision resolution with the UE 115-b.

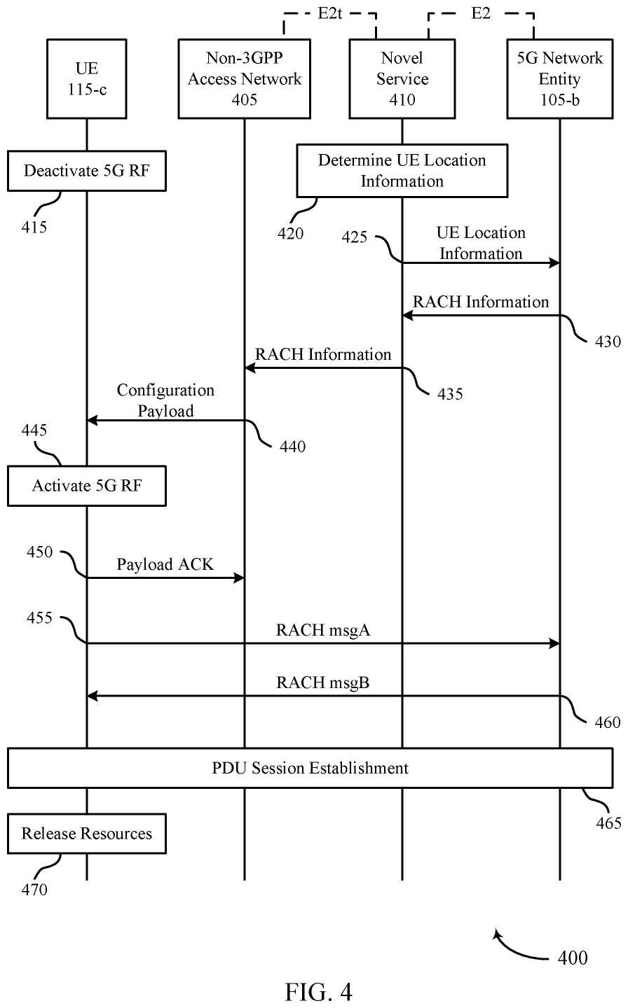

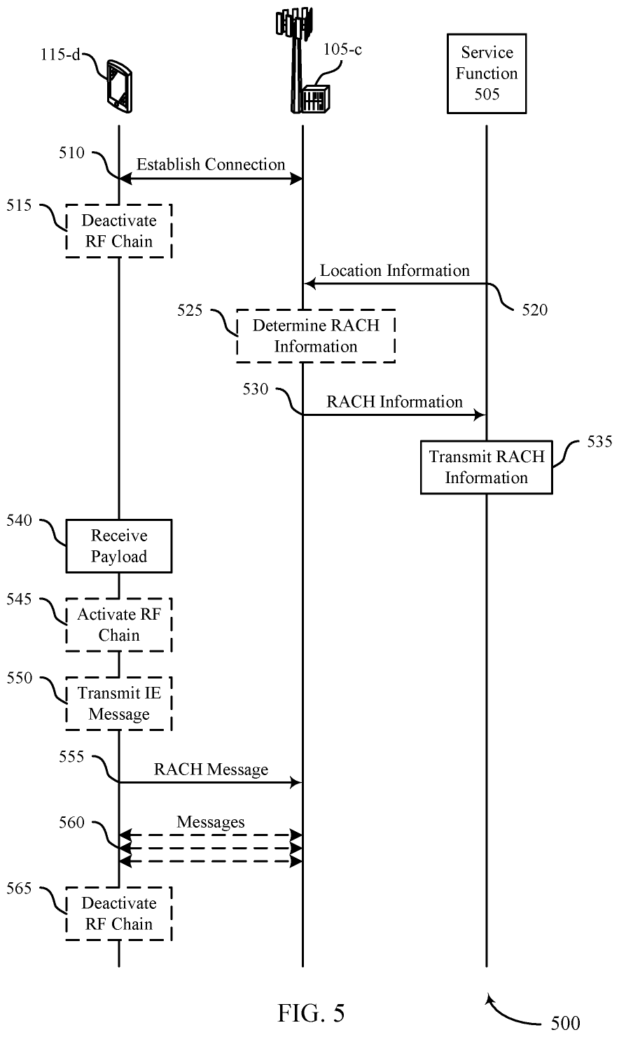

Techniques, systems, and devices described herein provide for reduced latency of handover between a non-3GPP network and a 3GPP network by utilizing a two-step CFRA RACH procedure. Such procedures may be utilized to reduce signaling overhead and latency during device registration to facilitate a reduced potential for message collision during device registration and a faster registration procedure between the UE 115-b and the 3GPP network, as described in further detail elsewhere herein, including with reference to FIGS. 4 and 5.

FIG. 4 shows an example of a flowchart 400 that supports random access techniques for handover from an access network in accordance with one or more aspects of the present disclosure. The flowchart 400 may implement or be implemented by aspects of the wireless communications system 100, the network architecture 200, and the wireless communications system 300, as described with reference to FIGS. 1-3. For example, the flowchart 400 illustrates actions performed by a client device (e.g., a UE 115-c), a 5G network entity 105-b, a non-3GPP access network 405, and a novel service 410, among other devices, as a part of a random access procedure during handover from a non-3GPP network to a 3GPP network. The devices and components described with reference to FIG. 4 may represent examples of corresponding devices and components as described with reference to FIGS. 1-3.

In the following description of the flowchart 400, the operations described may be performed in a different order than the order shown, or other operations may be added or removed from the flowchart 400. Specific operations may also be left out of the flowchart 400 or may be performed in different orders or at different times. Further, although some operations or signaling may be shown to occur at different times for discussion purposes, these operations may actually occur at the same time.

At 415, the UE 115-c may deactivate a 5G RF of the UE 115-c. In some examples, the UE 115-c may be connected to a core network (e.g., a 5G core network) via a non-3GPP access gateway (e.g., the non-3GPP access network 405). The non-3GPP access network 405 may be a TNGF or a non-3GPP interworking function (N3IWF) as described with reference to FIG. 2. Accordingly, the UE 115-c may not be using the 5G RF to communicate with the core network and may deactivate the 5G RF to conserve power.

At 420, the novel service 410 may determine location information of the UE 115-c. In some examples, the novel service 410 may act as a location management function (LFM) or a gateway mobile location center (GMLC) and may receive (e.g., periodically, continuously) precise position information of the UE 115-c. For example, the novel service 410 may be a near-RT RIC (e.g., a Near-RT RIC 175-b). The near-RT-RIC may be a closest (e.g., spatially) function to the non-3GPP access network and may be used to support lower-latency mobility functions. Additionally, or alternatively, the novel service 410 may query the position of the UE 115-c via LTE positioning protocol (LPP) messages. The novel service 410 may use the precise position information to determine whether the UE 115-c has entered a cell edge of the non-3GPP access network. In some cases, the novel service 410 may allocate the unique preamble and C-RNTI to the UE 115-c via the non-3GPP access network 405.

At 425, the novel service 410 may transmit the location information of the UE 115-c to the 5G network entity 105-b. For example, the novel service 410 may transmit a global identifier (ID) of the UE 115-c and the precise position information to the 5G network entity 105-b. The global ID may be a globally unique temporary identifier (GUTI) or a subscription permanent identifier (SUPI). In some examples, the novel service 410 may interface with the 5G network entity 105-b via a subscription-based interface (e.g., an E2 interface). In such examples, the novel service 410 may transmit the location information of the UE 115-c via an E2 application protocol (E2AP) RIC control request message.

At 430, the 5G network entity 105-b may transmit RACH information to the novel service 410. The RACH information may be allocated for the UE 115-c. For example, the RACH information may include a unique RACH preamble assignment and a cell-radio network temporary identifier (C-RNTI) for the UE 115-c. In some examples, the 5G network entity 105-b may determine the unique preamble and the C-RNTI based on the global ID and the precise position information of the UE 115-c. The 5G network entity 105-b may determine the unique preamble for the UE 115-c to remove the possibility of preamble collision at the destination 3GPP cell (e.g., the 5G network entity 105-b). The 5G network entity 105-b may transmit the RACH information to the novel service 410 via an E2AP RIC control acknowledgment (ACK) message.

At 435, the novel service 410 may transmit the RACH information to the non-3GPP access network 405. In some examples, the novel service 410 may update the RACH assignment information at the non-3GPP access network 405 with the RACH information for the UE 115-c (e.g., the unique preamble and the C-RNTI) from the 5G network entity 105-b. In some cases where the non-3GPP access network 405 is a trusted network, the novel service 410 may interface with the non-3GPP access network 405 via a trusted E2 interface (e.g., an E2-t interface). In some other cases where the non-3GPP access network 405 is an untrusted network, the novel service 410 may interface with the non-3GPP access network 405 via an untrusted E2 interface (e.g., an E2-u interface).

At 440, the non-3GPP access network 405 may transmit a configuration payload to the UE 115-c. In some examples, the non-3GPP access network may include the configuration payload in an information exchange (IE) message (e.g., an IKEv2 message). The configuration payload may include the unique preamble and the C-RNTI for the UE 115-c. In some cases, the configuration payload may be different from a delete (e.g., disconnect) payload of the IE message.

At 445, the UE 115-c may activate the 5G RF of the UE 115-c. In some examples, the UE 115-c may activate the 5G RF based on receiving the IE message from the non-3GPP access network 405. For example, the configuration payload of the IE message (e.g., the unique preamble and C-RNTI) may indicate for the UE 115-c to perform registration with the 5G network entity 105-b. The UE 115-c may activate the 5G RF to communicate with the 5G network entity 105-b.

At 450, the UE 115-c may transmit an ACK to the non-3GPP access network 405 indicating that it successfully received the configuration payload. In some examples, the UE 115-c may transmit an empty IE message to the non-3GPP access network 405 indicating that it successfully received the preamble and the C-RNTI included in the preamble. The empty IE message may not include a configuration payload or a delete payload.

At 455, the UE 115-c may transmit a first RACH message to the 5G network entity 105-b. In some examples, the first RACH message may be a two-step RACH msgA. For example, the UE 115-c may transmit both a PRACH including the unique preamble for the UE 115-c and a physical uplink shared channel (PUSCH) in the first RACH message. In some cases, the UE 115-c may transmit the first RACH message using a dedicated preamble ID and via one or more RACH occasions, the preamble ID and the RACH occasions selected for transmitting the unique preamble.

At 460, At 455, the UE 115-c may receive a second RACH message from the 5G network entity 105-b. In some examples, the second RACH message may be a two-step RACH msgB. For example, the 5G network entity 105-b may transmit both a RAR and a contention resolution message (e.g., RRC connection setup message) in the second RACH message.

At 465, the UE 115-c and the 5G network entity 105-b may perform PDU session establishment. In some examples, the UE 115-c and the 5G network entity 105-b may perform the PDU session establishment as a part of a successful registration procedure call flow.

At 470, the UE 115-c may release resources occupied by the non-3GPP network. In some examples, the UE 115-c may release the resources based on successful registration with the 5G network entity 105-b.

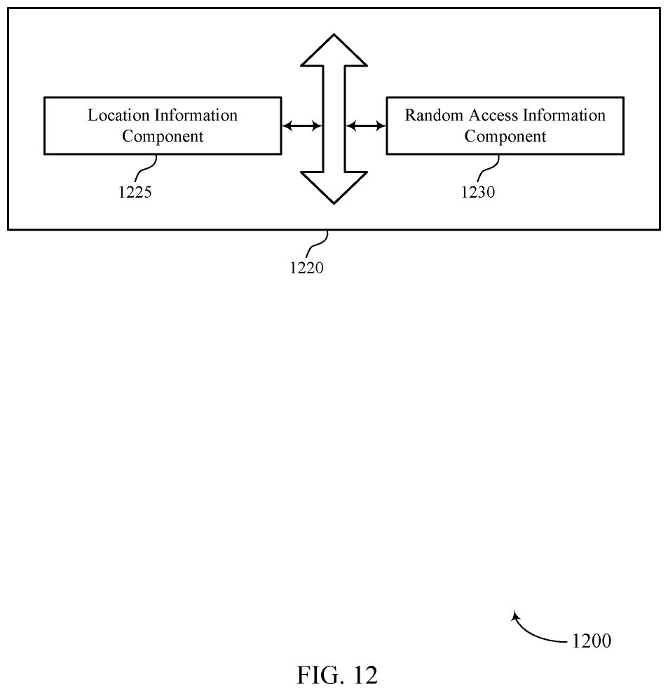

FIG. 5 shows an example of a process flow 500 that supports random access techniques for handover from an access network in accordance with one or more aspects of the present disclosure. The process flow 500 may implement or be implemented by aspects of the wireless communications system 100, the network architecture 200, and the wireless communications system 300, as described with reference to FIGS. 1-4. For example, the process flow 500 illustrates actions performed by a UE 115-d, a network entity 105-c, and a service function 505. The devices and components described with reference to FIG. 12 may represent examples of corresponding devices and components ad described with reference to FIGS. 1-4. For example, the service function 505 may be an example of a near-RT RIC as described with reference to FIGS. 2-4.

In the following description of the process flow 500, the operations described may be performed in a different order than the order shown, or other operations may be added or removed from the process flow 500. Specific operations may also be left out of the process flow 500 or may be performed in different orders or at different times. Further, although some operations or signaling may be shown to occur at different times for discussion purposes, these operations may actually occur at the same time.

At 510, the UE 115-c may establish, via a network function of an access network associated with a first radio access technology (RAT) type, a connection with a network of a second RAT type. In some examples, the first RAT type may be a wireless local area network (WLAN) RAT, such as Wi-Fi, and the second RAT type may be a cellular network RAT (e.g., a wireless wide area network (WWAN)), such as an LTE network, a 5G (or beyond) network. For example, the access network may be a N3IWF or a TNGF.

At 515, the UE 115-d may deactivate, after establishment of the connection with the network of the second RAT type via the network function, an RF chain associated with the second RAT type. In some examples, the UE 115-d may deactivate the RF chain associated with the second RAT type to conserve power.

At 520, the service function 505 may transmit location information associated with the UE 115-d that is connected, via the network function of the access network associated with the first RAT type, to the network associated with the second RAT type (e.g., the network entity 105-c). In some examples, the location information may comprise precise location information for the UE 115-d. Additionally, the location information may comprise a global ID and a current location of the UE 115-d. For example, the global ID may be a GUTI or a SUPI. In some examples, the service function 505 may transmit an E2AP RAN RIC control request message that comprises the location information. In some cases (e.g., if the access network is a trusted network), the service function 505 may transmit the location information via an E2-t interface. In some other cases (e.g., if the access network is an untrusted network), the service function 505 may transmit the location information via an E2-u interface.

At 525, the network entity 105-c may determine the random access information comprising a preamble and a temporary ID (e.g., C-RNTI) based at least in part on the location information associated with the UE 115-d. In some examples, the preamble may be unique to the UE 115-d.

At 530, the network entity 105-c may transmit, to the service function 505, the random access information for the second RAT type for the UE 115-d. The random access information may comprise the preamble for the UE 115-d and the temporary ID for the UE 115-d. In some cases, the preamble and the temporary ID may be based at least in part on the location information associated with the UE 115-d. In some examples, the network entity 105-c may transmit the random access information to the service function 505 via an E2AP RAN RIC control acknowledgment message.

At 535, the service function 505 may transmit, to the network function of the access network associated with the first RAT type, an indication of the random access information for the second RAT type for the UE 115-d.

At 540, the UE 115-d may receive, via the network function of the access network associated with the first RAT type, a message comprising a payload indicating random access information for the second RAT type for the UE. In some examples, the random access information may comprise the preamble for the UE 115-d and the temporary ID for the UE 115-d. In such examples, the preamble and the temporary ID may be based at least in part on the location information associated with the UE 115-d.

At 545, the UE 115-d may activate the RF chain associated with the second RAT type based at least in part on reception of the payload of the message indicating the random access information for the second RAT type for the UE 115-d. In some examples, the UE 115-d may activate the RF chain associated with the second RAT type to communicate with the network entity 105-c.

At 550, the UE 115-d may transmit, to the network function, an informational exchange message indicating that the UE 115-d received the message indicating the random access information. In some examples, the informational exchange message may comprise no payload or comprise one or more vendor-specific payloads.

At 555, the UE 115-d may transmit a random access message to the network entity 105-c associated with the second RAT type based at least in part on the message indicating the random access information. In some examples, the random access message may comprise the preamble for the UE 115-d and a request to connect with the network of the second RAT type. The UE 115-d may transmit a PRACH comprising the preamble and the temporary ID. For example, the random access message may be an initial message of a two-step random access procedure, and the initial message may comprise both the PRACH and a PUSCH comprising the request to connect with the network of the second RAT type.

At 560, the UE 115-d may communicate, after transmission of the random access message, with the network entity via the RF chain associated with the second RAT type. For example, the UE 115-d and the network entity 105-c may communicate (e.g., output or obtain) one or more messages based at least in part on reception of the random access message. In some examples, the one or more messages may comprise a successful RAR indicating that registration between the UE 115-d and the network entity 105-c was successful.

At 565, the UE 115-d may deactivate, after transmitting the random access message to the network entity 105-c, an RF chain associated with the first RAT type. For example, based on receiving the RAR indicating that registration between the UE 115-d and the network entity 105-c (e.g., the second RAT type) was successful, the UE 115-d may deactivate the RF chain associated with the first RAT type to conserve power.

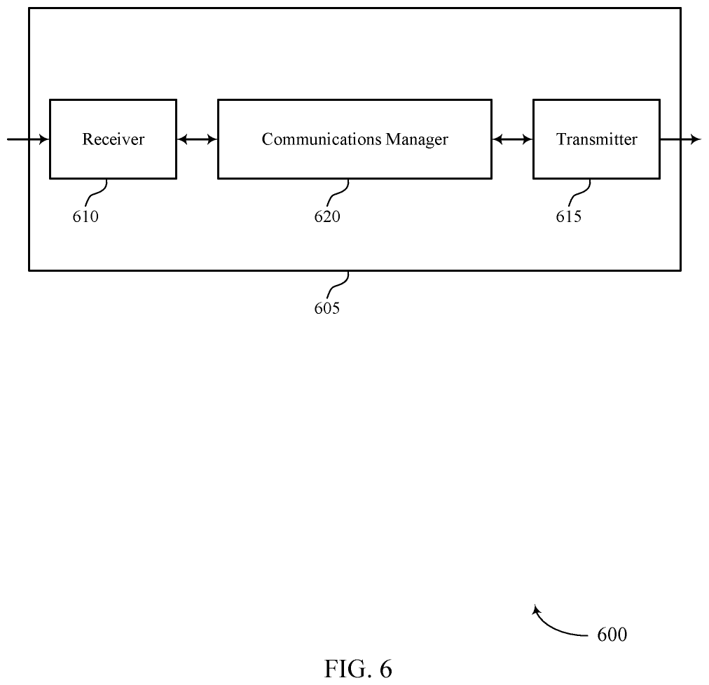

FIG. 6 shows a block diagram 600 of a device 605 that supports random access techniques for handover from an access network in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to random access techniques for handover from an access network). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to random access techniques for handover from an access network). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of random access techniques for handover from an access network as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for establishing, via a network function of an access network associated with a first RAT type, a connection with a network of a second RAT type. The communications manager 620 is capable of, configured to, or operable to support a means for receiving, via the network function, a message comprising a payload indicating random access information for the second RAT type for the UE, the random access information comprising a preamble for the UE and a temporary ID for the UE, where the preamble and the temporary ID are based at least in part on location information associated with the UE. The communications manager 620 is capable of, configured to, or operable to support a means for transmitting a random access message to a network entity associated with the second RAT type based at least in part on the message indicating the random access information, the random access message comprising the preamble for the UE and a request to connect with the network of the second RAT type.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

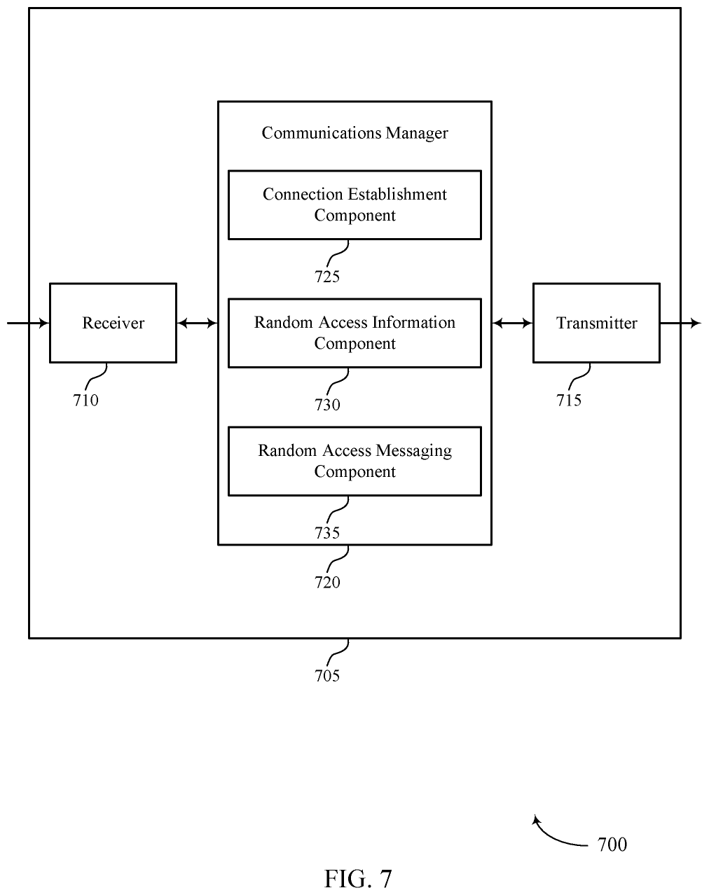

FIG. 7 shows a block diagram 700 of a device 705 that supports random access techniques for handover from an access network in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to random access techniques for handover from an access network). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to random access techniques for handover from an access network). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of random access techniques for handover from an access network as described herein. For example, the communications manager 720 may include a connection establishment component 725, a random access information component 730, a random access messaging component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The connection establishment component 725 is capable of, configured to, or operable to support a means for establishing, via a network function of an access network associated with a first RAT type, a connection with a network of a second RAT type. The random access information component 730 is capable of, configured to, or operable to support a means for receiving, via the network function, a message comprising a payload indicating random access information for the second RAT type for the UE, the random access information comprising a preamble for the UE and a temporary ID for the UE, where the preamble and the temporary ID are based at least in part on location information associated with the UE. The random access messaging component 735 is capable of, configured to, or operable to support a means for transmitting a random access message to a network entity associated with the second RAT type based at least in part on the message indicating the random access information, the random access message comprising the preamble for the UE and a request to connect with the network of the second RAT type.

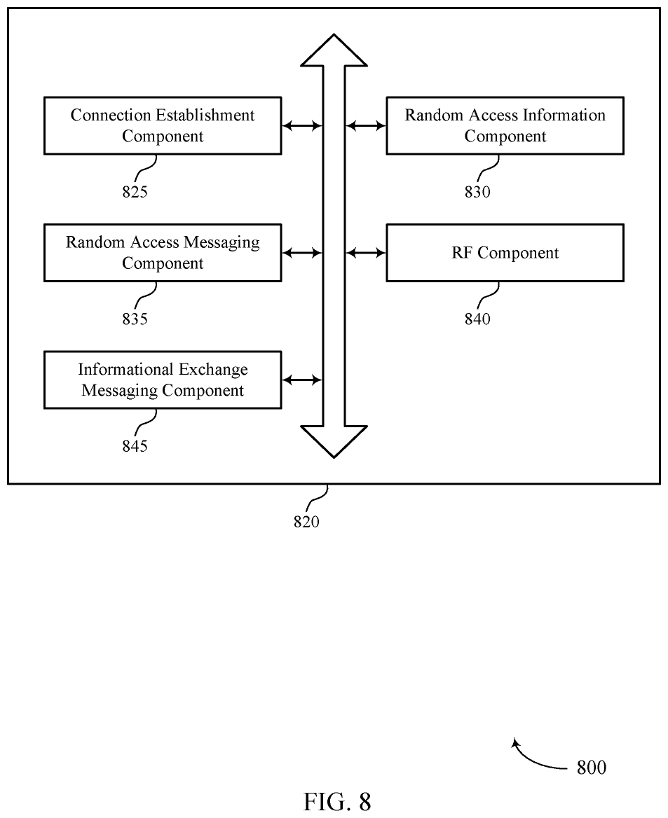

FIG. 8 shows a block diagram 800 of a communications manager 820 that supports random access techniques for handover from an access network in accordance with one or more aspects of the present disclosure. The communications manager 820 may be an example of aspects of a communications manager 620, a communications manager 720, or both, as described herein. The communications manager 820, or various components thereof, may be an example of means for performing various aspects of random access techniques for handover from an access network as described herein. For example, the communications manager 820 may include a connection establishment component 825, a random access information component 830, a random access messaging component 835, an RF component 840, an informational exchange messaging component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The connection establishment component 825 is capable of, configured to, or operable to support a means for establishing, via a network function of an access network associated with a first RAT type, a connection with a network of a second RAT type. The random access information component 830 is capable of, configured to, or operable to support a means for receiving, via the network function, a message comprising a payload indicating random access information for the second RAT type for the UE, the random access information comprising a preamble for the UE and a temporary ID for the UE, where the preamble and the temporary ID are based at least in part on location information associated with the UE. The random access messaging component 835 is capable of, configured to, or operable to support a means for transmitting a random access message to a network entity associated with the second RAT type based at least in part on the message indicating the random access information, the random access message comprising the preamble for the UE and a request to connect with the network of the second RAT type.

In some examples, the RF component 840 is capable of, configured to, or operable to support a means for deactivating, after establishment of the connection with the network of the second RAT type via the network function, a radio frequency (RF) chain associated with the second RAT type. In some examples, the RF component 840 is capable of, configured to, or operable to support a means for activating the RF chain associated with the second RAT type based at least in part on reception of the payload of the message indicating the random access information for the second RAT type for the UE.

In some examples, the informational exchange messaging component 845 is capable of, configured to, or operable to support a means for transmitting, to the network function, an informational exchange message indicating that the UE received the message indicating the random access information, the informational exchange message comprising no payload or comprising one or more vendor-specific payloads.

In some examples, to support transmitting the random access message, the informational exchange messaging component 845 is capable of, configured to, or operable to support a means for transmitting a physical random access channel (PRACH) including the preamble and the temporary ID.

In some examples, the random access message is an initial message of a two-step random access procedure, the initial message comprising both the PRACH and an PUSCH comprising the request to connect with the network of the second RAT type.

In some examples, the access network is a non-3GPP inter-working function (N3IWF) or a trusted non-3GPP gateway function (TNGF).

In some examples, the RF component 840 is capable of, configured to, or operable to support a means for communicating, after transmission of the random access message, with the network entity via a radio frequency (RF) chain associated with the second RAT type, where the random access information is based at least in part on precise location information for the UE.

In some examples, the RF component 840 is capable of, configured to, or operable to support a means for deactivating, after transmitting the random access message to the network entity, a radio frequency (RF) chain associated with the first RAT type.

In some examples, the preamble is unique to the UE.

In some examples, the first RAT type is a WLAN RAT and the second RAT type is a cellular network RAT.

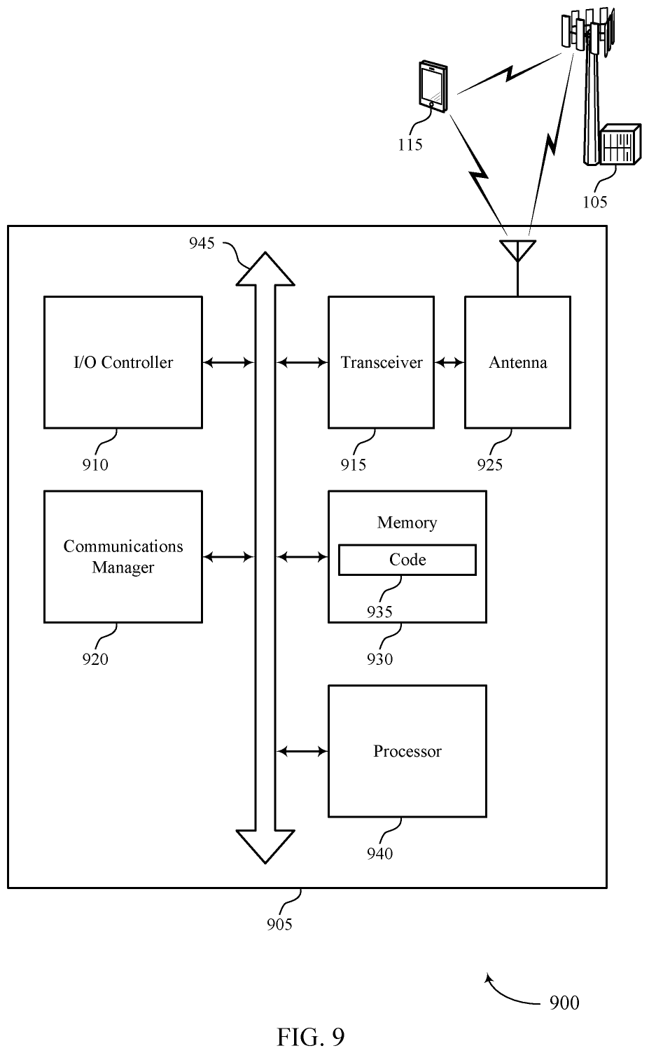

FIG. 9 shows a diagram of a system 900 including a device 905 that supports random access techniques for handover from an access network in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting random access techniques for handover from an access network). For example, the device 905 or a component of the device 905 may include at least one processor 940 and at least one memory 930 coupled with or to the at least one processor 940, the at least one processor 940 and the at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for establishing, via a network function of an access network associated with a first RAT type, a connection with a network of a second RAT type. The communications manager 920 is capable of, configured to, or operable to support a means for receiving, via the network function, a message comprising a payload indicating random access information for the second RAT type for the UE, the random access information comprising a preamble for the UE and a temporary ID for the UE, where the preamble and the temporary ID are based at least in part on location information associated with the UE. The communications manager 920 is capable of, configured to, or operable to support a means for transmitting a random access message to a network entity associated with the second RAT type based at least in part on the message indicating the random access information, the random access message comprising the preamble for the UE and a request to connect with the network of the second RAT type.

By including or configuring the communications manager 920 in accordance with examples as described herein, the device 905 may support techniques for reduced latency, improved user experience related to reduced processing, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of random access techniques for handover from an access network as described herein, or the at least one processor 940 and the at least one memory 930 may be otherwise configured to, individually or collectively, perform or support such operations.

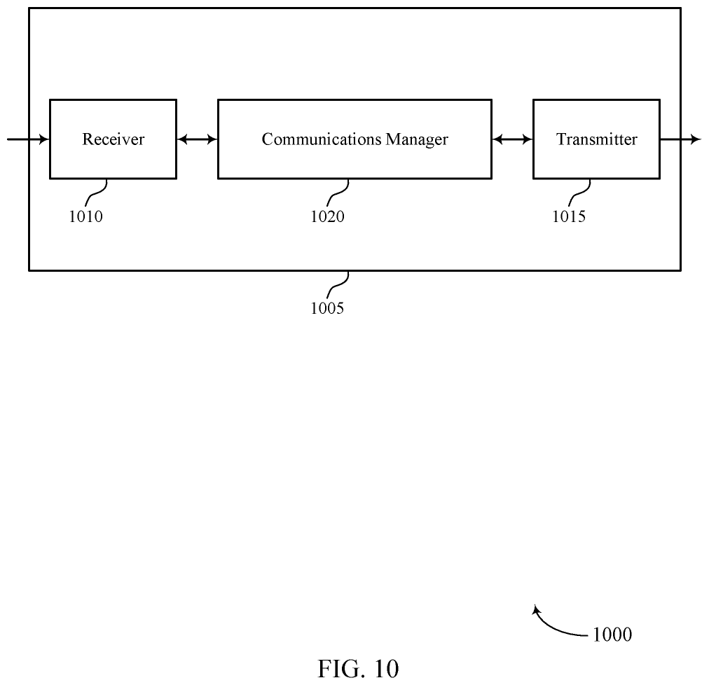

FIG. 10 shows a block diagram 1000 of a device 1005 that supports random access techniques for handover from an access network in accordance with one or more aspects of the present disclosure. The device 1005 may be an example of aspects of a service function as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The communications manager 1020, the receiver 1010, the transmitter 1015, or various combinations or components thereof may be examples of means for performing various aspects of random access techniques for handover from an access network as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

The communications manager 1020 may support wireless communications in accordance with examples as disclosed herein. For example, the communications manager 1020 is capable of, configured to, or operable to support a means for transmitting location information associated with a UE that is connected, via a network function of an access network associated with a first RAT type, to a network associated with a second RAT type, the location information comprising a global ID and a current location of the UE. The communications manager 1020 is capable of, configured to, or operable to support a means for receiving random access information for the second RAT type for the UE, the random access information comprising a preamble for the UE and a temporary ID for the UE, where the preamble and the temporary ID are based at least in part on the location information associated with the UE. The communications manager 1020 is capable of, configured to, or operable to support a means for transmitting, to the network function of the access network associated with the first RAT type, an indication of the random access information for the second RAT type for the UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

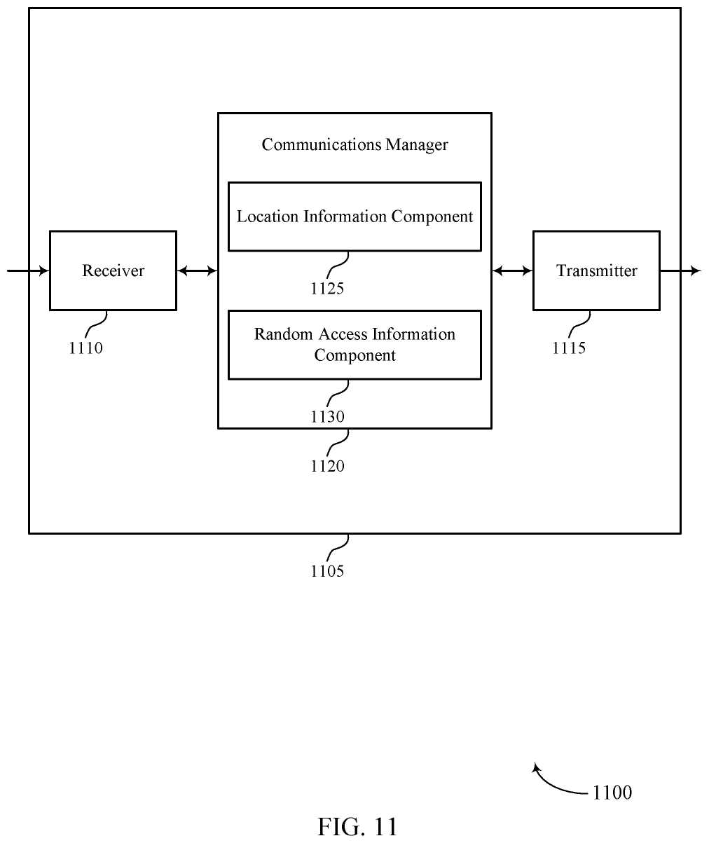

FIG. 11 shows a block diagram 1100 of a device 1105 that supports random access techniques for handover from an access network in accordance with one or more aspects of the present disclosure. The device 1105 may be an example of aspects of a device 1005 or a service function as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The device 1105, or various components thereof, may be an example of means for performing various aspects of random access techniques for handover from an access network as described herein. For example, the communications manager 1120 may include a location information component 1125 a random access information component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The location information component 1125 is capable of, configured to, or operable to support a means for transmitting location information associated with a UE that is connected, via a network function of an access network associated with a first RAT type, to a network associated with a second RAT type, the location information comprising a global ID and a current location of the UE. The random access information component 1130 is capable of, configured to, or operable to support a means for receiving random access information for the second RAT type for the UE, the random access information comprising a preamble for the UE and a temporary ID for the UE, where the preamble and the temporary ID are based at least in part on the location information associated with the UE. The random access information component 1130 is capable of, configured to, or operable to support a means for transmitting, to the network function of the access network associated with the first RAT type, an indication of the random access information for the second RAT type for the UE.

FIG. 12 shows a block diagram 1200 of a communications manager 1220 that supports random access techniques for handover from an access network in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of random access techniques for handover from an access network as described herein. For example, the communications manager 1220 may include a location information component 1225 a random access information component 1230, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The location information component 1225 is capable of, configured to, or operable to support a means for transmitting location information associated with a UE that is connected, via a network function of an access network associated with a first RAT type, to a network associated with a second RAT type, the location information comprising a global ID and a current location of the UE. The random access information component 1230 is capable of, configured to, or operable to support a means for receiving random access information for the second RAT type for the UE, the random access information comprising a preamble for the UE and a temporary ID for the UE, where the preamble and the temporary ID are based at least in part on the location information associated with the UE. In some examples, the random access information component 1230 is capable of, configured to, or operable to support a means for transmitting, to the network function of the access network associated with the first RAT type, an indication of the random access information for the second RAT type for the UE.

In some examples, to support transmitting the location information, the location information component 1225 is capable of, configured to, or operable to support a means for transmitting an E2 application protocol (E2AP) radio access network (RAN) intelligent controller (RIC) control request message that comprises the location information.

In some examples, to support transmitting the location information, the location information component 1225 is capable of, configured to, or operable to support a means for transmitting the location information via an E2-t interface.

In some examples, the service function is a near-real time radio access network (RAN) intelligent controller (near-RT RIC).

In some examples, the global ID is a globally unique temporary identifier (GUTI) or a subscription permanent identifier (SUPI).

In some examples, the preamble is unique to the UE.

In some examples, the first RAT type is a WLAN RAT and the second RAT type is a cellular network RAT.

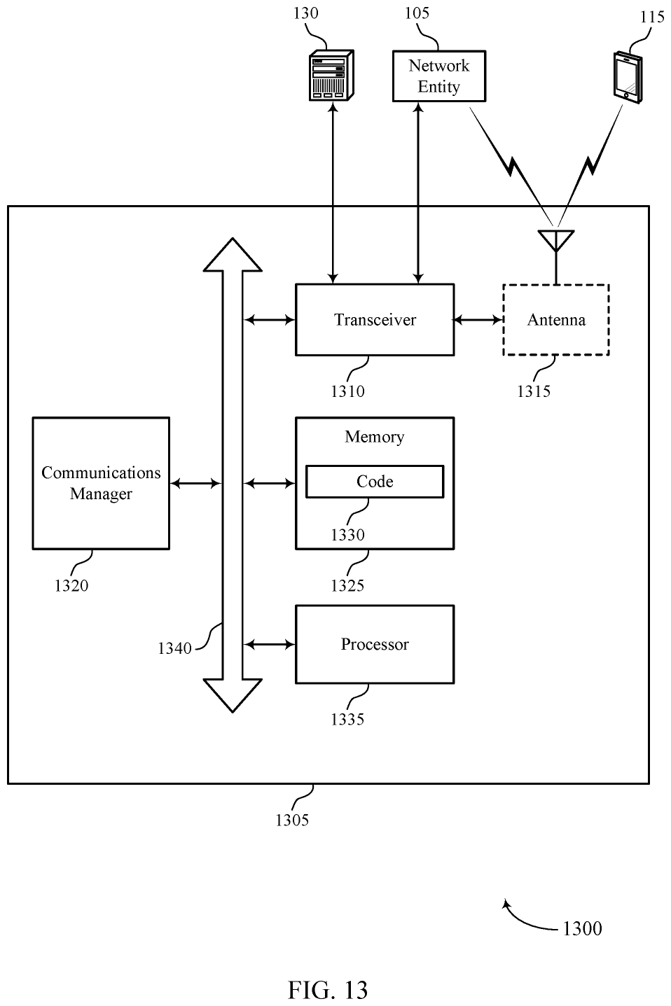

FIG. 13 shows a diagram of a system 1300 including a device 1305 that supports random access techniques for handover from an access network in accordance with one or more aspects of the present disclosure. The device 1305 may be an example of or include components of a device 1005, a device 1105, or a service function as described herein. The device 1305 may include components for bi-directional voice and data communications including components for transmitting and receiving communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The communications manager 1320 may support wireless communications in accordance with examples as disclosed herein. For example, the communications manager 1320 is capable of, configured to, or operable to support a means for transmitting location information associated with a UE that is connected, via a network function of an access network associated with a first RAT type, to a network associated with a second RAT type, the location information comprising a global ID and a current location of the UE. The communications manager 1320 is capable of, configured to, or operable to support a means for receiving random access information for the second RAT type for the UE, the random access information comprising a preamble for the UE and a temporary ID for the UE, where the preamble and the temporary ID are based at least in part on the location information associated with the UE. The communications manager 1320 is capable of, configured to, or operable to support a means for transmitting, to the network function of the access network associated with the first RAT type, an indication of the random access information for the second RAT type for the UE.

By including or configuring the communications manager 1320 in accordance with examples as described herein, the device 1305 may support techniques for reduced latency, improved user experience related to reduced processing, reduced power consumption, and more efficient utilization of communication resources.

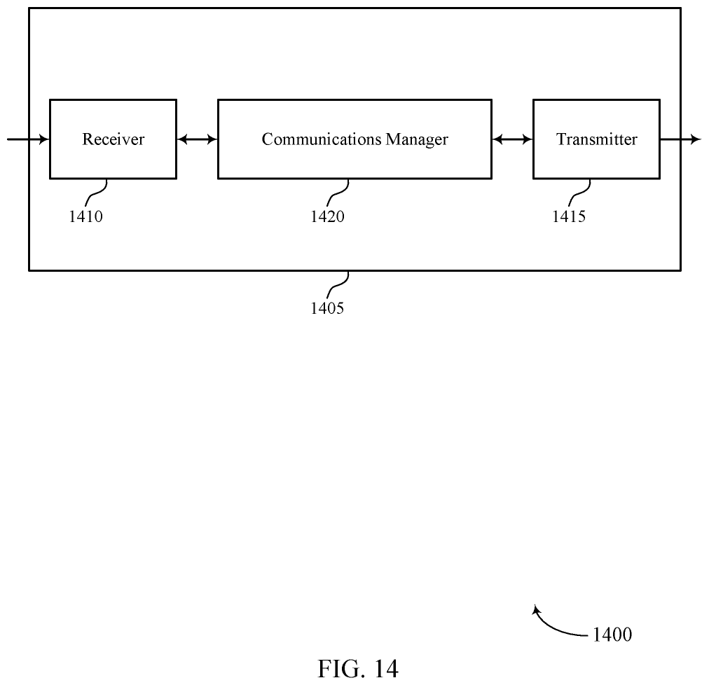

FIG. 14 shows a block diagram 1400 of a device 1405 that supports random access techniques for handover from an access network in accordance with one or more aspects of the present disclosure. The device 1405 may be an example of aspects of a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations or components thereof may be examples of means for performing various aspects of random access techniques for handover from an access network as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor (e.g., referred to as a processor-executable code). If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. For example, the communications manager 1420 is capable of, configured to, or operable to support a means for obtaining, from a service function, location information associated with a UE, the location information comprising a global ID and a current location of the UE. The communications manager 1420 is capable of, configured to, or operable to support a means for outputting random access information for the RAT type to the service function, the random access information comprising a preamble for the UE and a temporary ID for the UE, where the preamble and the temporary ID are based at least in part on the location information associated with the UE. The communications manager 1420 is capable of, configured to, or operable to support a means for obtaining a random access message from the UE based at least in part on the random access information, the random access message comprising the preamble for the UE and a request for the UE to connect with the network entity associated with the RAT type.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for reduced processing, reduced power consumption, and more efficient utilization of communication resources.

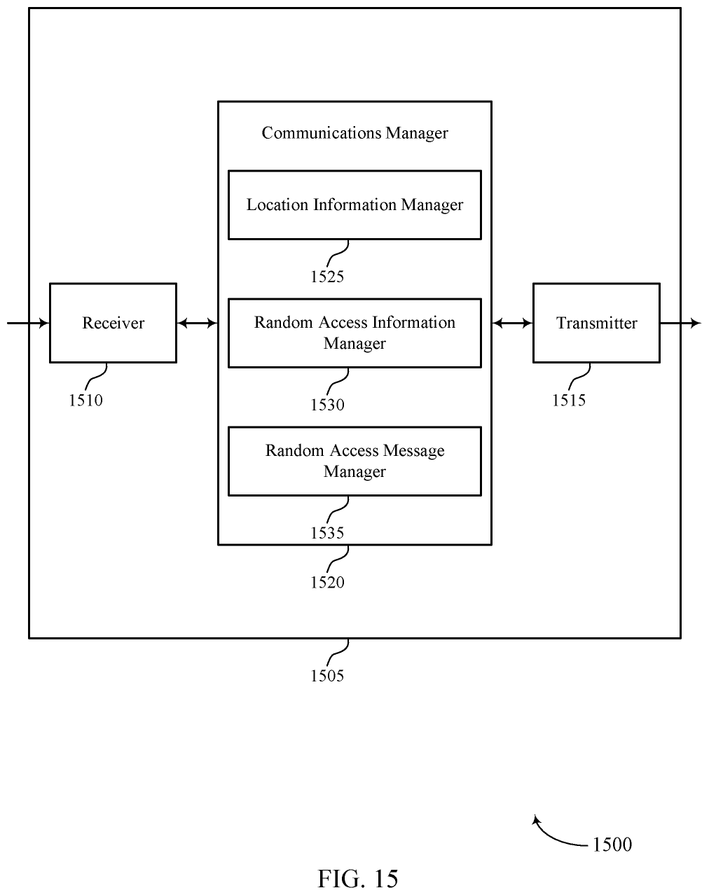

FIG. 15 shows a block diagram 1500 of a device 1505 that supports random access techniques for handover from an access network in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of random access techniques for handover from an access network as described herein. For example, the communications manager 1520 may include a location information manager 1525, a random access information manager 1530, a random access message manager 1535, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. The location information manager 1525 is capable of, configured to, or operable to support a means for obtaining, from a service function, location information associated with a UE, the location information comprising a global ID and a current location of the UE. The random access information manager 1530 is capable of, configured to, or operable to support a means for outputting random access information for the RAT type to the service function, the random access information comprising a preamble for the UE and a temporary ID for the UE, where the preamble and the temporary ID are based at least in part on the location information associated with the UE. The random access message manager 1535 is capable of, configured to, or operable to support a means for obtaining a random access message from the UE based at least in part on the random access information, the random access message comprising the preamble for the UE and a request for the UE to connect with the network entity associated with the RAT type.

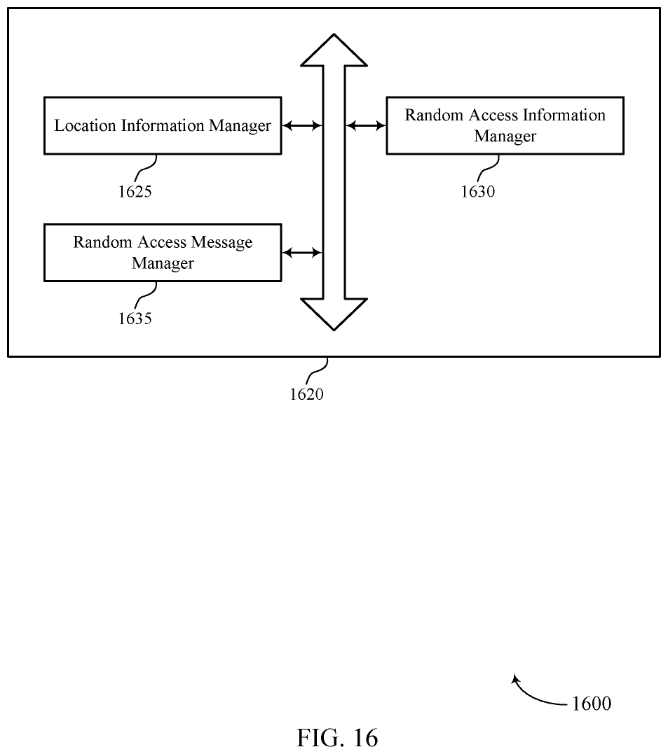

FIG. 16 shows a block diagram 1600 of a communications manager 1620 that supports random access techniques for handover from an access network in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of random access techniques for handover from an access network as described herein. For example, the communications manager 1620 may include a location information manager 1625, a random access information manager 1630, a random access message manager 1635, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications in accordance with examples as disclosed herein. The location information manager 1625 is capable of, configured to, or operable to support a means for obtaining, from a service function, location information associated with a UE, the location information comprising a global ID and a current location of the UE. The random access information manager 1630 is capable of, configured to, or operable to support a means for outputting random access information for the RAT type to the service function, the random access information comprising a preamble for the UE and a temporary ID for the UE, where the preamble and the temporary ID are based at least in part on the location information associated with the UE. The random access message manager 1635 is capable of, configured to, or operable to support a means for obtaining a random access message from the UE based at least in part on the random access information, the random access message comprising the preamble for the UE and a request for the UE to connect with the network entity associated with the RAT type.

In some examples, the random access information manager 1630 is capable of, configured to, or operable to support a means for determining the random access information comprising the preamble and the temporary ID based at least in part on the location information associated with the UE.

In some examples, to support outputting the random access information, the random access information manager 1630 is capable of, configured to, or operable to support a means for outputting the random access information to the service function via an E2 application protocol (E2AP) radio access network (RAN) intelligent controller (RIC) control acknowledgment message.

In some examples, the random access message manager 1635 is capable of, configured to, or operable to support a means for outputting or obtaining one or more messages with the UE based at least in part on reception of the random access message.

In some examples, the random access message manager 1635 is capable of, configured to, or operable to support a means for outputting or obtaining one or more messages with the UE, where the location information comprises precise location information for the UE.

In some examples, the preamble is unique to the UE.

In some examples, the RAT type is a cellular network RAT.

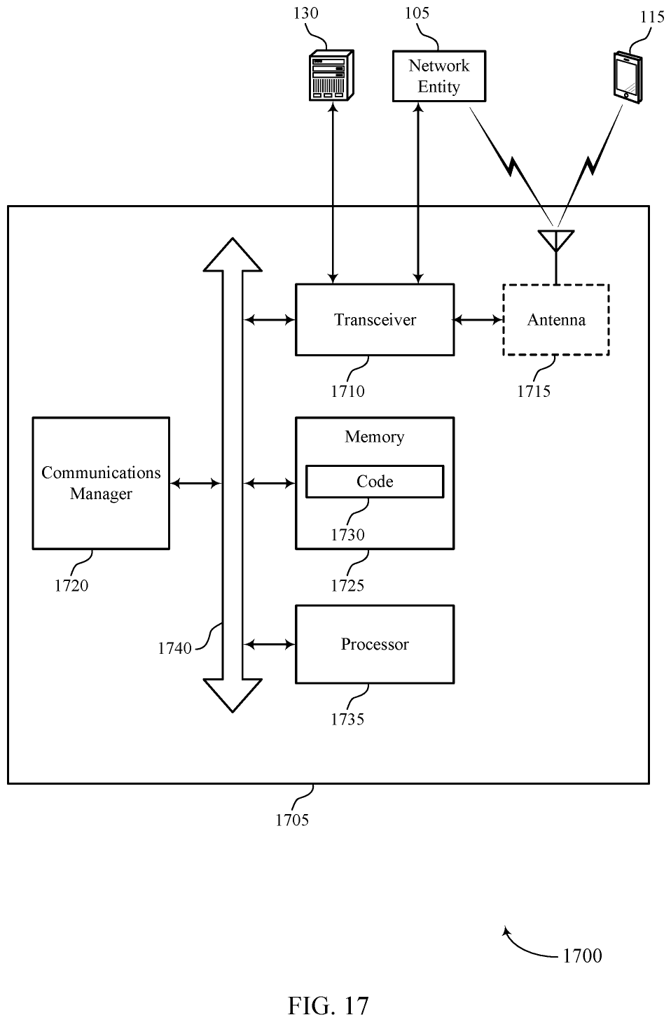

FIG. 17 shows a diagram of a system 1700 including a device 1705 that supports random access techniques for handover from an access network in accordance with one or more aspects of the present disclosure. The device 1705 may be an example of or include components of a device 1405, a device 1505, or a network entity 105 as described herein. The device 1705 may communicate with other network devices or network equipment such as one or more of the network entities 105, UEs 115, or any combination thereof. The communications may include communications over one or more wired interfaces, over one or more wireless interfaces, or any combination thereof. The device 1705 may include components that support outputting and obtaining communications, such as a communications manager 1720, a transceiver 1710, one or more antennas 1715, at least one memory 1725, code 1730, and at least one processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based at least in part on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (e.g., the at least one processor 1735, the at least one memory 1725, or both), may be included in a chip or chip assembly that is installed in the device 1705. In some examples, the transceiver 1710 may be operable to support communications via one or more communications links (e.g., communication link(s) 125, backhaul communication link(s) 120, a midhaul communication link 162, a fronthaul communication link 168).

The at least one memory 1725 may include RAM, ROM, or any combination thereof. The at least one memory 1725 may store computer-readable, computer-executable, or processor-executable code, such as the code 1730. The code 1730 may include instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (e.g., when compiled and executed) to perform functions described herein. In some cases, the at least one memory 1725 may include, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (e.g., one or more of the at least one memory 1725) to cause the device 1705 to perform various functions (e.g., functions or tasks supporting random access techniques for handover from an access network). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (e.g., one or more physical nodes and supporting software such as operating systems, virtual machines, or container instances) that may host the functions (e.g., by executing code 1730) to perform the functions of the device 1705. The at least one processor 1735 may be any one or more suitable processors capable of executing scripts or instructions of one or more software programs stored in the device 1705 (such as within one or more of the at least one memory 1725). In some examples, the at least one processor 1735 may include multiple processors and the at least one memory 1725 may include multiple memories. One or more of the multiple processors may be coupled with one or more of the multiple memories, which may, individually or collectively, be configured to perform various functions herein. In some examples, the at least one processor 1735 may be a component of a processing system, which may refer to a system (such as a series) of machines, circuitry (including, for example, one or both of processor circuitry (which may include the at least one processor 1735) and memory circuitry (which may include the at least one memory 1725)), or components, that receives or obtains inputs and processes the inputs to produce, generate, or obtain a set of outputs. The processing system may be configured to perform one or more of the functions described herein. For example, the at least one processor 1735 or a processing system including the at least one processor 1735 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code stored in the at least one memory 1725 or otherwise, to perform one or more of the functions described herein.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with one or more other network entities 105, and may include a controller or scheduler for controlling communications with UEs 115 (e.g., in cooperation with the one or more other network devices). In some examples, the communications manager 1720 may support an X2 interface within an LTE/LTE-A wireless communications network technology to provide communication between network entities 105.

The communications manager 1720 may support wireless communications in accordance with examples as disclosed herein. For example, the communications manager 1720 is capable of, configured to, or operable to support a means for obtaining, from a service function, location information associated with a UE, the location information comprising a global ID and a current location of the UE. The communications manager 1720 is capable of, configured to, or operable to support a means for outputting random access information for the RAT type to the service function, the random access information comprising a preamble for the UE and a temporary ID for the UE, where the preamble and the temporary ID are based at least in part on the location information associated with the UE. The communications manager 1720 is capable of, configured to, or operable to support a means for obtaining a random access message from the UE based at least in part on the random access information, the random access message comprising the preamble for the UE and a request for the UE to connect with the network entity associated with the RAT type.

By including or configuring the communications manager 1720 in accordance with examples as described herein, the device 1705 may support techniques for reduced latency, improved user experience related to reduced processing, reduced power consumption, and more efficient utilization of communication resources.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of random access techniques for handover from an access network as described herein, or the at least one processor 1735 and the at least one memory 1725 may be otherwise configured to, individually or collectively, perform or support such operations.

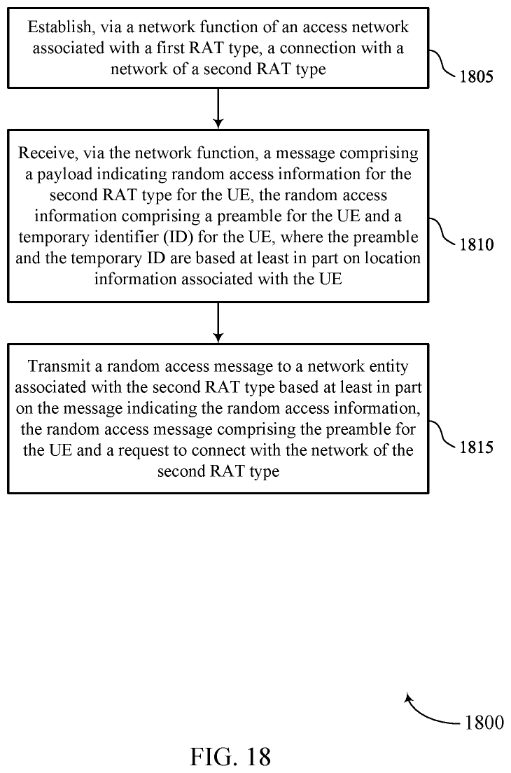

FIG. 18 shows a flowchart illustrating a method 1800 that supports random access techniques for handover from an access network in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may comprise establishing, via a network function of an access network associated with a first RAT type, a connection with a network of a second RAT type. The operations of 1805 may be performed in accordance with examples as disclosed herein. In some examples, aspects of the operations of 1805 may be performed by a connection establishment component 825 as described with reference to FIG. 8.

At 1810, the method may comprise receiving, via the network function, a message comprising a payload indicating random access information for the second RAT type for the UE, the random access information comprising a preamble for the UE and a temporary ID for the UE, where the preamble and the temporary ID are based at least in part on location information associated with the UE. The operations of 1810 may be performed in accordance with examples as disclosed herein. In some examples, aspects of the operations of 1810 may be performed by a random access information component 830 as described with reference to FIG. 8.

At 1815, the method may comprise transmitting a random access message to a network entity associated with the second RAT type based at least in part on the message indicating the random access information, the random access message comprising the preamble for the UE and a request to connect with the network of the second RAT type. The operations of 1815 may be performed in accordance with examples as disclosed herein. In some examples, aspects of the operations of 1815 may be performed by a random access messaging component 835 as described with reference to FIG. 8.

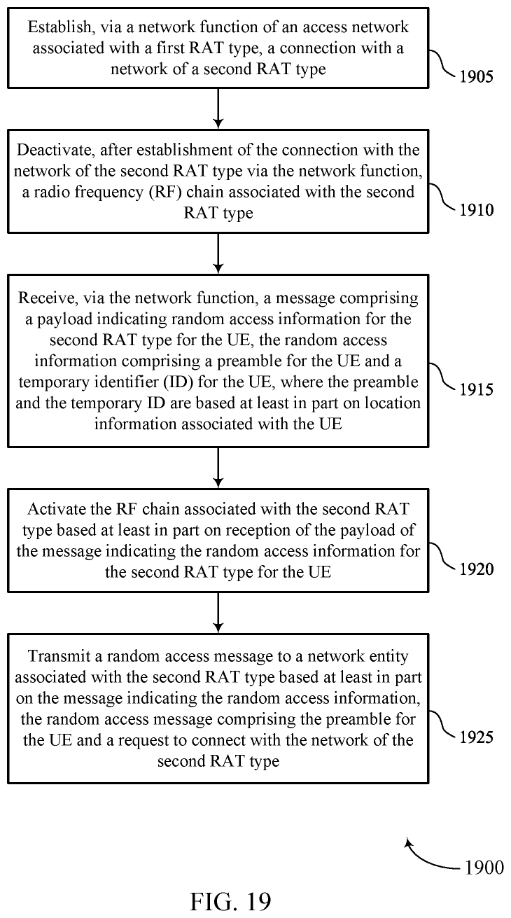

FIG. 19 shows a flowchart illustrating a method 1900 that supports random access techniques for handover from an access network in accordance with one or more aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1905, the method may comprise establishing, via a network function of an access network associated with a first RAT type, a connection with a network of a second RAT type. The operations of 1905 may be performed in accordance with examples as disclosed herein. In some examples, aspects of the operations of 1905 may be performed by a connection establishment component 825 as described with reference to FIG. 8.

At 1910, the method may comprise deactivating, after establishment of the connection with the network of the second RAT type via the network function, a radio frequency (RF) chain associated with the second RAT type. The operations of 1910 may be performed in accordance with examples as disclosed herein. In some examples, aspects of the operations of 1910 may be performed by an RF component 840 as described with reference to FIG. 8.

At 1915, the method may comprise receiving, via the network function, a message comprising a payload indicating random access information for the second RAT type for the UE, the random access information comprising a preamble for the UE and a temporary ID for the UE, where the preamble and the temporary ID are based at least in part on location information associated with the UE. The operations of 1915 may be performed in accordance with examples as disclosed herein. In some examples, aspects of the operations of 1915 may be performed by a random access information component 830 as described with reference to FIG. 8.

At 1920, the method may comprise activating the RF chain associated with the second RAT type based at least in part on reception of the payload of the message indicating the random access information for the second RAT type for the UE. The operations of 1920 may be performed in accordance with examples as disclosed herein. In some examples, aspects of the operations of 1920 may be performed by an RF component 840 as described with reference to FIG. 8.

At 1925, the method may comprise transmitting a random access message to a network entity associated with the second RAT type based at least in part on the message indicating the random access information, the random access message comprising the preamble for the UE and a request to connect with the network of the second RAT type. The operations of 1925 may be performed in accordance with examples as disclosed herein. In some examples, aspects of the operations of 1925 may be performed by a random access messaging component 835 as described with reference to FIG. 8.

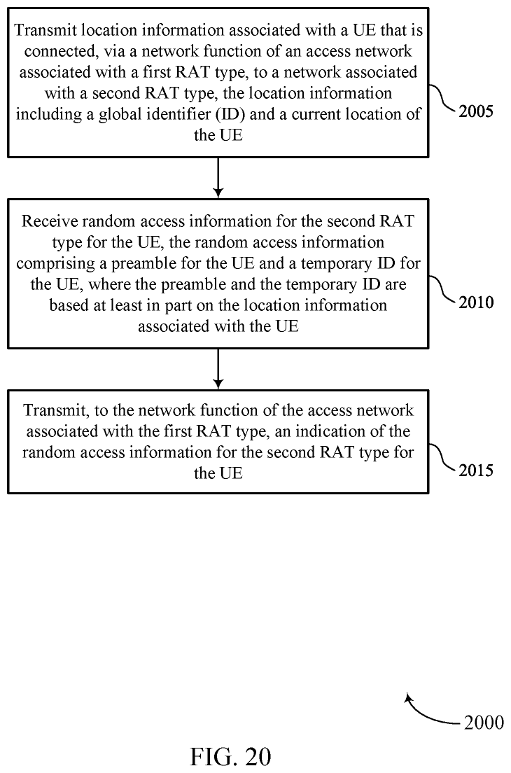

FIG. 20 shows a flowchart illustrating a method 2000 that supports random access techniques for handover from an access network in accordance with one or more aspects of the present disclosure. The operations of the method 2000 may be implemented by a service function or its components as described herein. For example, the operations of the method 2000 may be performed by a service function as described with reference to FIGS. 1 through 5 and 10 through 13. In some examples, a service function may execute a set of instructions to control the functional elements of the service function to perform the described functions. Additionally, or alternatively, the service function may perform aspects of the described functions using special-purpose hardware.

At 2005, the method may comprise transmitting location information associated with a UE that is connected, via a network function of an access network associated with a first RAT type, to a network associated with a second RAT type, the location information comprising a global ID and a current location of the UE. The operations of 2005 may be performed in accordance with examples as disclosed herein. In some examples, aspects of the operations of 2005 may be performed by a location information component 1225 as described with reference to FIG. 12.

At 2010, the method may comprise receiving random access information for the second RAT type for the UE, the random access information comprising a preamble for the UE and a temporary ID for the UE, where the preamble and the temporary ID are based at least in part on the location information associated with the UE. The operations of 2010 may be performed in accordance with examples as disclosed herein. In some examples, aspects of the operations of 2010 may be performed by a random access information component 1230 as described with reference to FIG. 12.

At 2015, the method may comprise transmitting, to the network function of the access network associated with the first RAT type, an indication of the random access information for the second RAT type for the UE. The operations of 2015 may be performed in accordance with examples as disclosed herein. In some examples, aspects of the operations of 2015 may be performed by a random access information component 1230 as described with reference to FIG. 12.

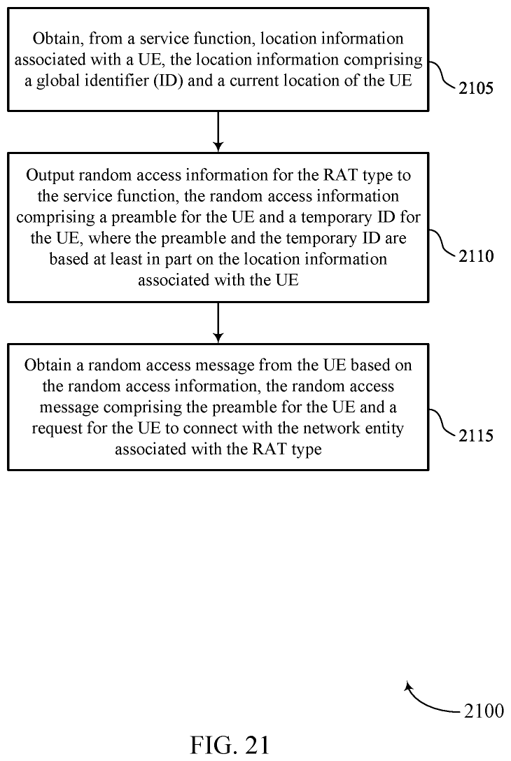

FIG. 21 shows a flowchart illustrating a method 2100 that supports random access techniques for handover from an access network in accordance with one or more aspects of the present disclosure. The operations of the method 2100 may be implemented by a network entity or its components as described herein. For example, the operations of the method 2100 may be performed by a network entity as described with reference to FIGS. 1 through 5 and 14 through 17. In some examples, a network entity may execute a set of instructions to control the functional elements of the network entity to perform the described functions. Additionally, or alternatively, the network entity may perform aspects of the described functions using special-purpose hardware.

At 2105, the method may comprise obtaining, from a service function, location information associated with a UE, the location information comprising a global ID and a current location of the UE. The operations of 2105 may be performed in accordance with examples as disclosed herein. In some examples, aspects of the operations of 2105 may be performed by a location information manager 1625 as described with reference to FIG. 16.

At 2110, the method may comprise outputting random access information for the RAT type to the service function, the random access information comprising a preamble for the UE and a temporary ID for the UE, where the preamble and the temporary ID are based at least in part on the location information associated with the UE. The operations of 2110 may be performed in accordance with examples as disclosed herein. In some examples, aspects of the operations of 2110 may be performed by a random access information manager 1630 as described with reference to FIG. 16.

At 2115, the method may comprise obtaining a random access message from the UE based at least in part on the random access information, the random access message comprising the preamble for the UE and a request for the UE to connect with the network entity associated with the RAT type. The operations of 2115 may be performed in accordance with examples as disclosed herein. In some examples, aspects of the operations of 2115 may be performed by a random access message manager 1635 as described with reference to FIG. 16.

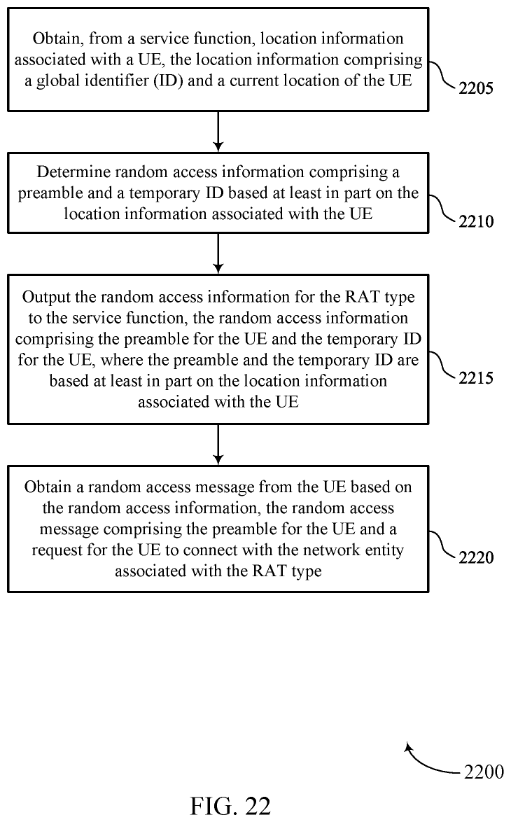

FIG. 22 shows a flowchart illustrating a method 2200 that supports random access techniques for handover from an access network in accordance with one or more aspects of the present disclosure. The operations of the method 2200 may be implemented by a network entity or its components as described herein. For example, the operations of the method 2200 may be performed by a network entity as described with reference to FIGS. 1 through 5 and 14 through 17. In some examples, a network entity may execute a set of instructions to control the functional elements of the network entity to perform the described functions. Additionally, or alternatively, the network entity may perform aspects of the described functions using special-purpose hardware.

At 2205, the method may comprise obtaining, from a service function, location information associated with a UE, the location information comprising a global ID and a current location of the UE. The operations of 2205 may be performed in accordance with examples as disclosed herein. In some examples, aspects of the operations of 2205 may be performed by a location information manager 1625 as described with reference to FIG. 16.

At 2210, the method may comprise determining the random access information comprising the preamble and the temporary ID based at least in part on the location information associated with the UE. The operations of 2210 may be performed in accordance with examples as disclosed herein. In some examples, aspects of the operations of 2210 may be performed by a random access information manager 1630 as described with reference to FIG. 16.

At 2215, the method may comprise outputting random access information for the RAT type to the service function, the random access information comprising a preamble for the UE and a temporary ID for the UE, where the preamble and the temporary ID are based at least in part on the location information associated with the UE. The operations of 2215 may be performed in accordance with examples as disclosed herein. In some examples, aspects of the operations of 2215 may be performed by a random access information manager 1630 as described with reference to FIG. 16.

At 2220, the method may comprise obtaining a random access message from the UE based at least in part on the random access information, the random access message comprising the preamble for the UE and a request for the UE to connect with the network entity associated with the RAT type. The operations of 2220 may be performed in accordance with examples as disclosed herein. In some examples, aspects of the operations of 2220 may be performed by a random access message manager 1635 as described with reference to FIG. 16.

The following provides an overview of aspects of the present disclosure:

Aspect 1: A method for wireless communications at a UE, comprising: establishing, via a network function of an access network associated with a first RAT type, a connection with a network of a second RAT type; receiving, via the network function, a message comprising a payload indicating random access information for the second RAT type for the UE, the random access information comprising a preamble for the UE and a temporary ID for the UE, wherein the preamble and the temporary ID are based at least in part on location information associated with the UE; and transmitting a random access message to a network entity associated with the second RAT type based at least in part on the message indicating the random access information, the random access message comprising the preamble for the UE and a request to connect with the network of the second RAT type.

Aspect 2: The method of aspect 1, further comprising: deactivating, after establishment of the connection with the network of the second RAT type via the network function, a RF chain associated with the second RAT type; and activating the RF chain associated with the second RAT type based at least in part on reception of the payload of the message indicating the random access information for the second RAT type for the UE.

Aspect 3: The method of any of aspects 1 through 2, further comprising: transmitting, to the network function, an informational exchange message indicating that the UE received the message indicating the random access information, the informational exchange message comprising no payload or comprising one or more vendor-specific payloads.

Aspect 4: The method of aspect 3, wherein transmitting the random access message comprises: transmitting a PRACH comprising the preamble and the temporary ID.

Aspect 5: The method of aspect 4, wherein the random access message is an initial message of a two-step random access procedure, the initial message comprising both the PRACH and a PUSCH comprising the request to connect with the network of the second RAT type.

Aspect 6: The method of any of aspects 1 through 5, wherein the access network is a N3IWF or a TNGF.

Aspect 7: The method of any of aspects 1 through 6, further comprising: communicating, after transmission of the random access message, with the network entity via a RF chain associated with the second RAT type, wherein the random access information is based at least in part on precise location information for the UE.

Aspect 8: The method of any of aspects 1 through 7, further comprising: deactivating, after transmitting the random access message to the network entity, a RF chain associated with the first RAT type.

Aspect 9: The method of any of aspects 1 through 8, wherein the preamble is unique to the UE.

Aspect 10: The method of any of aspects 1 through 9, wherein the first RAT type is a WLAN RAT and the second RAT type is a cellular network RAT.

Aspect 11: A method for wireless communications at a service function, comprising: transmitting location information associated with a UE that is connected, via a network function of an access network associated with a first RAT type, to a network associated with a second RAT type, the location information comprising a global ID and a current location of the UE; receiving random access information for the second RAT type for the UE, the random access information comprising a preamble for the UE and a temporary ID for the UE, wherein the preamble and the temporary ID are based at least in part on the location information associated with the UE; and transmitting, to the network function of the access network associated with the first RAT type, an indication of the random access information for the second RAT type for the UE.

Aspect 12: The method of aspect 11, wherein transmitting the location information comprises: transmitting an E2AP RAN RIC control request message that comprises the location information.

Aspect 13: The method of any of aspects 11 through 12, wherein transmitting the location information comprises: transmitting the location information via an E2-t interface.

Aspect 14: The method of any of aspects 11 through 13, wherein the service function is a near-RT RIC.

Aspect 15: The method of any of aspects 11 through 14, wherein the global ID is a GUTI or a SUPI.

Aspect 16: The method of any of aspects 11 through 15, wherein the preamble is unique to the UE.

Aspect 17: The method of any of aspects 11 through 16, wherein the first RAT type is a WLAN RAT and the second RAT type is a cellular network RAT.

Aspect 18: A method for wireless communications at a network entity associated with a RAT type, comprising: obtaining, from a service function, location information associated with a UE, the location information comprising a global ID and a current location of the UE; outputting random access information for the RAT type to the service function, the random access information comprising a preamble for the UE and a temporary ID for the UE, wherein the preamble and the temporary ID are based at least in part on the location information associated with the UE; and obtaining a random access message from the UE based at least in part on the random access information, the random access message comprising the preamble for the UE and a request for the UE to connect with the network entity associated with the RAT type.

Aspect 19: The method of aspect 18, further comprising: determining the random access information comprising the preamble and the temporary ID based at least in part on the location information associated with the UE.

Aspect 20: The method of any of aspects 18 through 19, wherein outputting the random access information comprises: outputting the random access information to the service function via an E2AP RAN RIC control acknowledgment message.

Aspect 21: The method of any of aspects 18 through 20, further comprising: outputting or obtaining one or more messages with the UE based at least in part on reception of the random access message.

Aspect 22: The method of any of aspects 18 through 21, further comprising: outputting or obtaining one or more messages with the UE, wherein the location information comprises precise location information for the UE.

Aspect 23: The method of any of aspects 18 through 22, wherein the preamble is unique to the UE.

Aspect 24: The method of any of aspects 18 through 23, wherein the RAT type is a cellular network RAT.

Aspect 25: A UE for wireless communications, comprising one or more memories storing processor-executable code, and one or more processors coupled with the one or more memories and individually or collectively operable to execute the code to cause the UE to perform a method of any of aspects 1 through 10.

Aspect 26: A UE for wireless communications, comprising at least one means for performing a method of any of aspects 1 through 10.

Aspect 27: A non-transitory computer-readable medium storing code for wireless communications, the code comprising instructions executable by one or more processors to perform a method of any of aspects 1 through 10.

Aspect 28: A service function for wireless communications, comprising one or more memories storing processor-executable code, and one or more processors coupled with the one or more memories and individually or collectively operable to execute the code to cause the service function to perform a method of any of aspects 11 through 17.

Aspect 29: A service function for wireless communications, comprising at least one means for performing a method of any of aspects 11 through 17.

Aspect 30: A non-transitory computer-readable medium storing code for wireless communications, the code comprising instructions executable by one or more processors to perform a method of any of aspects 11 through 17.

Aspect 31: A network entity associated with a RAT type for wireless communications, comprising one or more memories storing processor-executable code, and one or more processors coupled with the one or more memories and individually or collectively operable to execute the code to cause the network entity associated with a RAT type to perform a method of any of aspects 18 through 24.

Aspect 32: A network entity associated with a RAT type for wireless communications, comprising at least one means for performing a method of any of aspects 18 through 24.

Aspect 33: A non-transitory computer-readable medium storing code for wireless communications, the code comprising instructions executable by one or more processors to perform a method of any of aspects 18 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
establish, via a network function of an access network associated with a first radio access technology (RAT) type, a connection with a network of a second RAT type;
receive, via the network function, a message comprising a payload indicating random access information for the second RAT type for the UE, the random access information comprising a preamble for the UE and a temporary identifier (ID) for the UE, wherein the preamble and the temporary ID are based at least in part on location information associated with the UE; and
transmit a random access message to a network entity associated with the second RAT type based at least in part on the message indicating the random access information, the random access message comprising the preamble for the UE and a request to connect with the network of the second RAT type.

2. The UE of claim 1, wherein the one or more processors are individually or collectively further operable to execute the code to cause the UE to:
deactivate, after establishment of the connection with the network of the second RAT type via the network function, a radio frequency (RF) chain associated with the second RAT type; and
activate the RF chain associated with the second RAT type based at least in part on reception of the payload of the message indicating the random access information for the second RAT type for the UE.

3. The UE of claim 1, wherein the one or more processors are individually or collectively further operable to execute the code to cause the UE to:
transmit, to the network function, an informational exchange message indicating that the UE received the message indicating the random access information, the informational exchange message comprising no payload or comprising one or more vendor-specific payloads.

4. The UE of claim 3, wherein, to transmit the random access message, the one or more processors are individually or collectively operable to execute the code to cause the UE to:
transmit a physical random access channel (PRACH) comprising the preamble and the temporary ID.

5. The UE of claim 4, wherein the random access message is an initial message of a two-step random access procedure, the initial message comprising both the PRACH and a physical uplink shared channel (PUSCH) comprising the request to connect with the network of the second RAT type.

6. The UE of claim 1, wherein the access network is a non-3GPP inter-working function (N3IWF) or a trusted non-3GPP gateway function (TNGF).

7. The UE of claim 1, wherein the one or more processors are individually or collectively further operable to execute the code to cause the UE to:
communicate, after transmission of the random access message, with the network entity via a radio frequency (RF) chain associated with the second RAT type, wherein the random access information is based at least in part on precise location information for the UE.

8. The UE of claim 1, wherein the one or more processors are individually or collectively further operable to execute the code to cause the UE to:
deactivate, after transmitting the random access message to the network entity, a radio frequency (RF) chain associated with the first RAT type.

9. The UE of claim 1, wherein the preamble is unique to the UE.

10. The UE of claim 1, wherein the first RAT type is a wireless local area network (WLAN) RAT and the second RAT type is a cellular network RAT.

11. A service function, comprising:
one or more memories storing processor-executable code; and
one or more processors coupled with the one or more memories and individually or collectively operable to execute the code to cause the service function to:
transmit location information associated with a user equipment (UE) that is connected, via a network function of an access network associated with a first radio access technology (RAT) type, to a network associated with a second RAT type, the location information comprising a global identifier (ID) and a current location of the UE;
receive random access information for the second RAT type for the UE, the random access information comprising a preamble for the UE and a temporary ID for the UE, wherein the preamble and the temporary ID are based at least in part on the location information associated with the UE; and
transmit, to the network function of the access network associated with the first RAT type, an indication of the random access information for the second RAT type for the UE.

12. The service function of claim 11, wherein, to transmit the location information, the one or more processors are individually or collectively operable to execute the code to cause the service function to:
transmit an E2 application protocol (E2AP) radio access network (RAN) intelligent controller (RIC) control request message that comprises the location information.

13. The service function of claim 11, wherein, to transmit the location information, the one or more processors are individually or collectively operable to execute the code to cause the service function to:
transmit the location information via an E2-t interface.

14. The service function of claim 11, wherein the service function is a near-real time radio access network (RAN) intelligent controller (near-RT RIC).

15. The service function of claim 11, wherein the global ID is a globally unique temporary identifier (GUTI) or a subscription permanent identifier (SUPI).

16. The service function of claim 11, wherein the preamble is unique to the UE.

17. The service function of claim 11, wherein the first RAT type is a wireless local area network (WLAN) RAT and the second RAT type is a cellular network RAT.

18. A network entity associated with a radio access technology (RAT) type, comprising:
one or more memories storing processor-executable code; and
one or more processors coupled with the one or more memories and individually or collectively operable to execute the code to cause the network entity associated with a RAT type to:
obtain, from a service function, location information associated with a user equipment (UE), the location information comprising a global identifier (ID) and a current location of the UE;
output random access information for the RAT type to the service function, the random access information comprising a preamble for the UE and a temporary ID for the UE, wherein the preamble and the temporary ID are based at least in part on the location information associated with the UE; and
obtain a random access message from the UE based at least in part on the random access information, the random access message comprising the preamble for the UE and a request for the UE to connect with the network entity associated with the RAT type.

19. The network entity associated with a RAT type of claim 18, wherein the one or more processors are individually or collectively further operable to execute the code to cause the network entity associated with a RAT type to:
determine the random access information comprising the preamble and the temporary ID based at least in part on the location information associated with the UE.

20. The network entity associated with a RAT type of claim 18, wherein, to output the random access information, the one or more processors are individually or collectively operable to execute the code to cause the network entity associated with a RAT type to:
output the random access information to the service function via an E2 application protocol (E2AP) radio access network (RAN) intelligent controller (RIC) control acknowledgment message.

21. The network entity associated with a RAT type of claim 18, wherein the one or more processors are individually or collectively further operable to execute the code to cause the network entity associated with a RAT type to:
output or obtain one or more messages with the UE based at least in part on reception of the random access message.

22. The network entity associated with a RAT type of claim 18, wherein the one or more processors are individually or collectively further operable to execute the code to cause the network entity associated with a RAT type to:
output or obtain one or more messages with the UE, wherein the location information comprises precise location information for the UE.

23. The network entity associated with a RAT type of claim 18, wherein the preamble is unique to the UE.

24. The network entity associated with a RAT type of claim 18, wherein the RAT type is a cellular network RAT.

25. A method for wireless communications at a user equipment (UE), comprising:
establishing, via a network function of an access network associated with a first radio access technology (RAT) type, a connection with a network of a second RAT type;
receiving, via the network function, a message comprising a payload indicating random access information for the second RAT type for the UE, the random access information comprising a preamble for the UE and a temporary ID for the UE, wherein the preamble and the temporary ID are based at least in part on location information associated with the UE; and
transmitting a random access message to a network entity associated with the second RAT type based at least in part on the message indicating the random access information, the random access message comprising the preamble for the UE and a request to connect with the network of the second RAT type.

26. The method of claim 25, further comprising:
deactivating, after establishment of the connection with the network of the second RAT type via the network function, a radio frequency (RF) chain associated with the second RAT type; and
activating the RF chain associated with the second RAT type based at least in part on reception of the payload of the message indicating the random access information for the second RAT type for the UE.

27. The method of claim 25, further comprising:
transmitting, to the network function, an informational exchange message indicating that the UE received the message indicating the random access information, the informational exchange message comprising no payload or comprising one or more vendor-specific payloads.

28. The method of claim 27, wherein transmitting the random access message comprises:
transmitting a physical random access channel (PRACH) comprising the preamble and the temporary ID.

29. The method of claim 25, further comprising:
communicating, after transmission of the random access message, with the network entity via a radio frequency (RF) chain associated with the second RAT type, wherein the random access information is based at least in part on precise location information for the UE.

30. The method of claim 25, further comprising:
deactivating, after transmitting the random access message to the network entity, a radio frequency (RF) chain associated with the first RAT type.
